(19) United States
(12) Patent Application Publication
(10) Pub. No.: US 2016/0080609 A1
(43) Pub. Date: Mar. 17, 2016

(54) INFORMATION PROCESSING SYSTEM, PRINTING APPARATUS, INFORMATION PROCESSING METHOD, AND INFORMATION PROCESSING PROGRAM

(71) Applicant: KONICA MINOLTA, INC., Tokyo (JP)

(72) Inventor: Ryouhei INADA, Tokyo (JP)

(73) Assignee: KONICA MINOLTA, INC., Tokyo (JP)

(21) Appl. No.: 14/854,263

(22) Filed: Sep. 15, 2015

(30) Foreign Application Priority Data
Sep. 16, 2014 (JP) 2014-188227

(51) Int. Cl. H04N 1/60; H04N 1/00

(52) U.S. Cl. CPC H04N 1/6033; H04N 1/00724; H04N 2201/0094

(57) ABSTRACT

The information processing system includes an accumulation unit for accumulating a print result as result data, an input acceptance unit for accepting input of color standard information indicating a standard of a print color and paper property information indicating a property of a print paper, an acquisition unit for acquiring print property information indicating a property of a printing apparatus that performs printing on the print paper, a determination unit for referring the color standard information and the paper property information, which have been input to the input acceptance unit, and the print property information, which has been acquired in the acquisition unit, to the result data of the accumulation unit, and determining whether printing complying with a standard based on the color standard information is possible in the printing apparatus, and a notification unit for notifying a determination result thereof.

### CROSS-REFERENCE TO RELATED APPLICATION

This application is based on Japanese Patent Application No. 2014-188227 filed on Sep. 16, 2014, the contents of which are incorporated herein by reference.

### BACKGROUND

1. Technical Field

The present invention relates to an information processing system, a printing apparatus, an information processing method, and an information processing program.

2. Description of Related Arts

In recent years, in a production print field predicted to be extensively used in commercial printing, in-company printing, etc., higher quality printing is required.

Therefore, there is a case in which printing is performed with a color complying with a standard of a printing color such as “Japan Color certification”. Determination regarding whether printing can be performed with the color complying with the standard is performed by printing a color verification chart and measuring the color of a plurality of patches (1600 point or more in Japan Color certification). Since print quality largely depends on a used print paper, it is ideal that the determination regarding whether printing can be performed with the color complying with the standard is performed whenever a new print paper is used. However, if test printing for color measurement is performed whenever a paper is changed, many waste papers (loss papers not used as a product) are generated and it is further disadvantageous in that effort of a user increases.

Furthermore, when determining whether printing can be performed with the color complying with the standard, it is also considered to use past print results. For example, Unexamined Japanese Patent Publication No. 2012-169866 discloses a method in which in order to perform appropriate color reproduction for an unknown print paper, a print paper with similar spectral reflectivity is specified from past print results and color adjustment for the specified print paper is performed.

However, even in the case of using the method disclosed in Unexamined Japanese Patent Publication No. 2012-169866, it is possible to consider only the property (the spectral reflectivity) of the print paper. Therefore, since the property of a printing apparatus (an output apparatus), for example, expressible color gamut, etc., is not considered, it is not possible to accurately determine whether a print color complies with a standard.

### SUMMARY

The present invention is intended to solve the aforementioned problems in the prior art, and one of the objectives of the present invention is to provide an information processing system, etc., capable of accurately determining whether a print color complies with a standard while reducing the generation of waste papers and effort of a user.

In order to achieve at least one of the aforementioned objectives, an information processing system, reflecting one aspect of the present invention, includes: an accumulation unit for accumulating a print result as result data; an input acceptance unit for accepting input of color standard information indicating a standard of a print color and paper property information indicating a property of a print paper; an acquisition unit for acquiring print property information indicating a property of a printing apparatus that performs printing on said print paper; a determination unit for referring said color standard information and said paper property information, which have been input to said input acceptance unit, and said print property information, which has been acquired in said acquisition unit, to said result data of said accumulation unit, and determining whether printing to be performed complies with a standard based on said color standard information; and a notification unit for notifying a determination result determined by said determination unit.

The objectives, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a schematic configuration diagram of an information processing system.

FIG. 2 is a block diagram showing a hardware configuration example of a server.

FIG. 3 is a block diagram showing a hardware configuration example (a first embodiment) of a printing apparatus.

FIG. 4 is a block diagram showing a functional configuration example (a first embodiment) of an information processing system.

FIG. 5 is a flowchart of a compliance notification process (a first embodiment).

FIG. 6 is a diagram showing a display example of a first input screen.

FIG. 7 is a diagram showing a display example of a second input screen.

FIG. 8 is a diagram showing a schematic data structure example of inquiry data (a first embodiment).

FIG. 9 is a diagram showing a first display example of a notification screen.

FIG. 10 is a diagram showing a second display example of a notification screen.

FIG. 11 is a flowchart of a color verification process.

FIG. 12 is a diagram showing a schematic data structure example of a color verification chart.

FIG. 13 is a diagram showing an example of a reference value registered in advance as a color value of each patch constituting a color verification chart.

FIG. 14 is a diagram showing a schematic data structure example (a first embodiment) of color verification result data.

FIG. 15 is a flowchart of a result data accumulation process.

FIG. 16 is a diagram showing a schematic data structure example (a first embodiment) of accumulation data.

FIG. 17 is a flowchart of a compliance determination process.

FIG. 18 is a diagram for explaining an extraction method (a first embodiment) of determination data.

FIGS. 19A and 19B are a diagram for explaining a method (a first embodiment) for determining the possibility of compliance with a standard by using determination data.

FIGS. 20A-20C are a diagram showing an example when “compliance is possible”, “compliance is not possible”, and “determination is not possible” are determined.

FIG. 21 is a block diagram showing a hardware configuration example (a second embodiment) of a printing apparatus.

FIG. 22 is a block diagram showing a functional configuration example (a second embodiment) of an information processing system.

FIG. 23 is a flowchart of a compliance notification process (a second embodiment).

FIG. 24 is a diagram showing a third display example (a second embodiment) of a notification screen.

FIG. 25 is a flowchart of a compliance possibility inquiry process (a second embodiment).

FIG. 26 is a diagram showing a schematic data structure example (a second embodiment) of inquiry data for compliance possibility determination.

FIG. 27 is a diagram showing a schematic data structure example (a second embodiment) of color verification result data.

FIG. 28 is a schematic data structure example (a second embodiment) of result data.

FIG. 29 is a flowchart of a compliance possibility determination process (a second embodiment).

FIG. 30 is a diagram for explaining an extraction method (a second embodiment) of determination data.

FIGS. 31A-31C are a diagram showing an example when it is determined that compliance with a standard is possible.

FIGS. 32A-32C are a diagram showing an example 1 when it is determined that compliance with a standard is not possible.

FIGS. 33A-33C are a diagram showing an example 2 when it is determined that compliance with a standard is not possible.

### DETAILED DESCRIPTION

The embodiments of this invention will be described below with reference to the accompanying drawings. In addition, in a description of the drawings, the same reference numerals are used to designate the same elements and a redundant description will be omitted. Furthermore, the dimension ratio of each drawing is exaggerated for the sake of description, and may differ from an actual ratio.

### First Embodiment

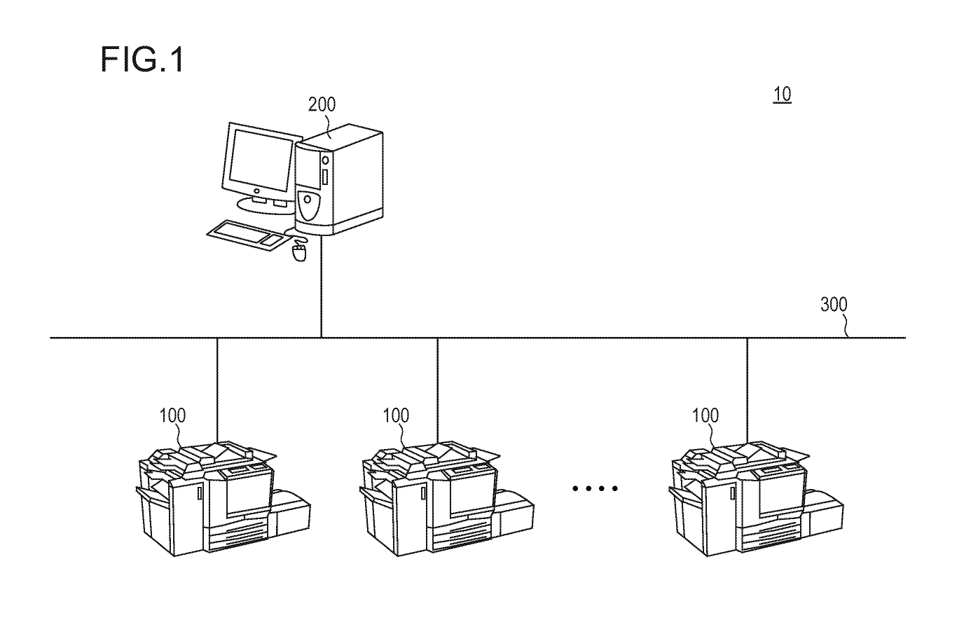

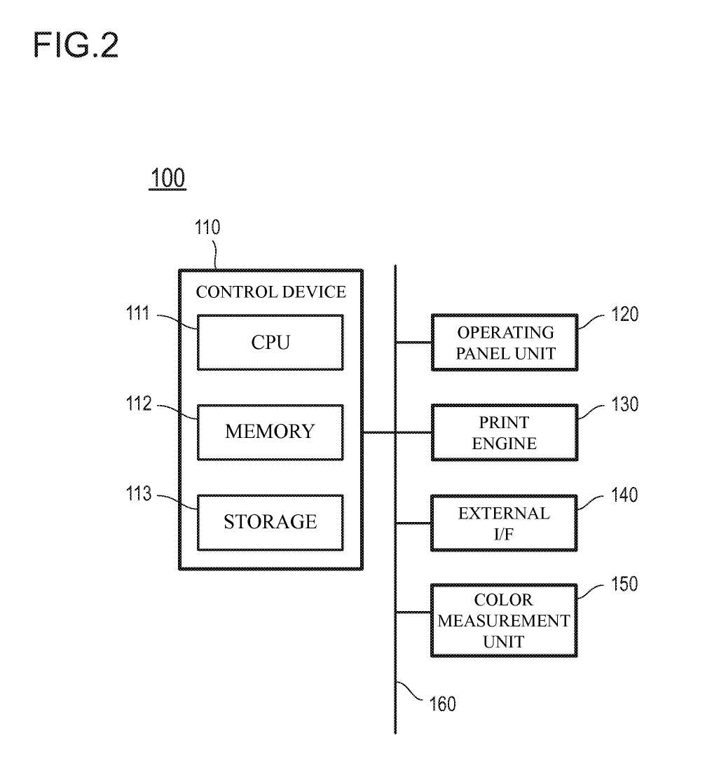

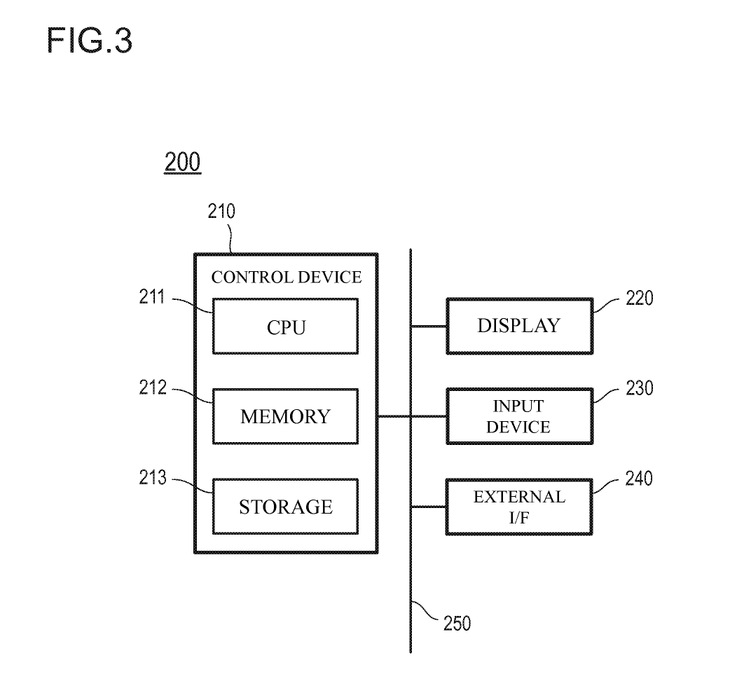

Firstly, with reference to FIG. 1 to FIG. 20, a first embodiment of the present invention will be described. FIG. 1 is a schematic configuration diagram of an information processing system. FIG. 2 is a block diagram showing a hardware configuration example of a server. FIG. 3 is a block diagram showing a hardware configuration example (a first embodiment) of a printing apparatus. Hereinafter, with reference to FIG. 1 to FIG. 3, a schematic configuration of an information processing system 10, particularly, a hardware configuration will be described.

### [Information Processing System 10 (Hardware Configuration)]

### (1) Entire Configuration

As shown in FIG. 1, the information processing system 10 includes one or more printing apparatuses 100 and a server 200. However, the type and the number of devices constituting the information processing system 10 are not limited to an example shown in FIG. 1.

The printing apparatus 100 is a printer (a production print machine, etc.) having at least a print function. For example, the printing apparatus 100 performs printing based on a print job transmitted from a computer (not shown, may also be the server 200) in which a printer driver has been installed. Furthermore, before printing, the printing apparatus 100 can inquire of the server 200 about whether printing complying with a designated standard is possible.

In addition, the printing apparatus 100 may be a copy machine, a facsimile machine, MFP (Multi-Function Peripheral), etc., if they have a print function.

The server 200 is a general computer (a personal computer, etc.). The server 200 collects and manages information on results of printing performed in the printing apparatus 100, particularly, information on colors. Furthermore, an inquiry from the printing apparatus 100 intended to perform printing is received, the server 200 determines (estimates) whether the printing complies with a standard and provides a determination result to the printing apparatus 100. The standard indicates a standard related to print colors. The standard stipulates a target reference color, a permission range (a predetermined threshold value) of color deviation from the reference color, etc., in order to perform stable printing. For example, the standard includes “Japan Color”, “SWOP”, “JMPA Color”, etc. The SWOP is an abbreviation for Specifications for Web Offset Publications. Furthermore, the JMPA is an abbreviation for Japan Magazine Publishers Association.

The printing apparatus 100 and the server 200 are connected to be able to communicate with each other via a communication network 300. The communication network 300 includes a computer network such as LAN (Local Area Network), WAN (Wide Area Network), and the Internet regardless of wired and wireless networks. However, the present invention is not limited thereto, and the communication network 300 may also include PAN (Personal Area Network), etc., using USB (a registered trademark), FireWire (a registered trademark), IrDA (a registered trademark), Bluetooth (a registered trademark), etc. Furthermore, the communication network 300 may also include a public network such as a telephone network, ISDN (Integrated Services Digital Network), and a packet switched network.

### (2) Printing Apparatus 100 (Hardware Configuration)

Next, a hardware configuration of the printing apparatus 100 will be described.

As shown in FIG. 2, the printing apparatus 100 has a control device 110, an operating panel unit 120, a print engine 130, an external I/F 140, and a color measurement unit 150, wherein these are connected to one another via a signal line (a bus, etc.) 160 for exchanging signals.

The control device 110 controls the whole of the printing apparatus 100. For example, the control device 110 has a CPU (Central Processing Unit) 111, a memory 112, and a storage 113.

The CPU 111 is a control circuit configured by a multicore processor, etc., which perform control of the aforementioned each element and various types of calculations according to a program, and each function of the printing apparatus 100 is performed when the CPU 111 executes programs corresponding to the functions.

The memory 112 is a work area and is a high speed accessible main storage device that temporarily stores programs and data. The memory 112, for example, employs DRAM (Dynamic Random Access Memory), SDRAM (Synchronous Dynamic Random Access Memory), SRAM (Static Random Access Memory), etc.

The storage 113 is an auxiliary storage device with a large capacity, which stores various programs including firmware and various types of data. The storage 113, for example, employs a hard disk, a solid state drive, a flash memory, ROM (Read Only Memory), etc.

The operating panel unit 120 is configured by attaching a transmissive touch panel (not shown) to a display surface side of a display (not shown). The touch panel specifies a touch position corresponding to XY coordinates of an image displayed on the display, converts the touch position into a coordinate, and outputs the coordinate. In addition, the touch panel is configured by a pressure sensitive or electrostatic input detection element, etc. Input to the touch panel is performed by intuitive touch operation. For example, the input is performed by touching a part of a key (or a button, an icon, a tool bar, and a predetermined area) displayed on the display by using a finger or a stylus (a pen).

Furthermore, the operating panel unit 120 may also include physical keys such as a numeric keypad, a start key, and a stop key.

The print engine 130 prints a color image on a print paper, which is a print medium, by using color materials of cyan (C), magenta (M), yellow (Y), and black (K) by a known imaging process of an electrophotographic scheme, etc. However, the present invention is not limited thereto, and the print engine 130 may also print a color image by using color materials of red (R), green (G), blue (B), etc. Furthermore, the present invention is not limited to the electrophotographic scheme, and the print engine 130 may also employ other schemes including an ink jet scheme.

The external interface (I/F) 140 is an interface for communicating with an external apparatus (for example, the server 200 or a general computer (not shown)) via the communication network 300.

The color measurement unit 150 measures a color of a result (a printed matter) printed on a print paper, and converts a measurement result into a color value and a density. For example, as the color measurement unit 150, a general spectrophotometer is used. However, the present invention is not limited thereto, and an in-line sensor may also be arranged on a conveyance path of a printed matter to measure a color.

### (3) Server 200 (Hardware Configuration)

Next, a hardware configuration of the server 200 will be described.

As shown in FIG. 3, the server 200 has a control device 210, a display 220, an input device 230, and an external I/F 240, wherein these are connected to one another via a signal line (a bus, etc.) 250 for exchanging signals.

The control device 210 controls the whole of the server 200. For example, the control device 210 has a CPU 211, a memory 212, and a storage 213.

The CPU 211 is a control circuit configured by a multicore processor, etc., which perform control of the aforementioned each element and various types of calculations according to a program, and each function of the server 200 is performed when the CPU 211 executes programs corresponding to the functions.

The memory 212 is a work area and is a high speed accessible main storage device that temporarily stores programs and data. The memory 212, for example, employs DRAM, SDRAM, SRAM, etc.

The storage 213 is an auxiliary storage device with a large capacity, which stores various programs including an operating system and various types of data. The storage 213, for example, employs a hard disk, a solid state drive, a flash memory, ROM, etc.

The display 220 displays various types of data such as information necessary for operating the server 200 and setting information. The display 220, for example, employs a liquid crystal display, an organic EL (Electron-Luminescence), etc.

The input device 230 inputs various types of data according to an instruction from a user. The input device 230, for example, employs a pointing device such as a keyboard and a mouse.

The external I/F 240 is an interface for communicating with an external apparatus (for example, the printing apparatus 100) via the communication network 300.

### [Information Processing System 10 (Functional Configuration)]

The printing apparatus 100 and the server 200 having the aforementioned hardware configurations have the following functional functions, respectively.

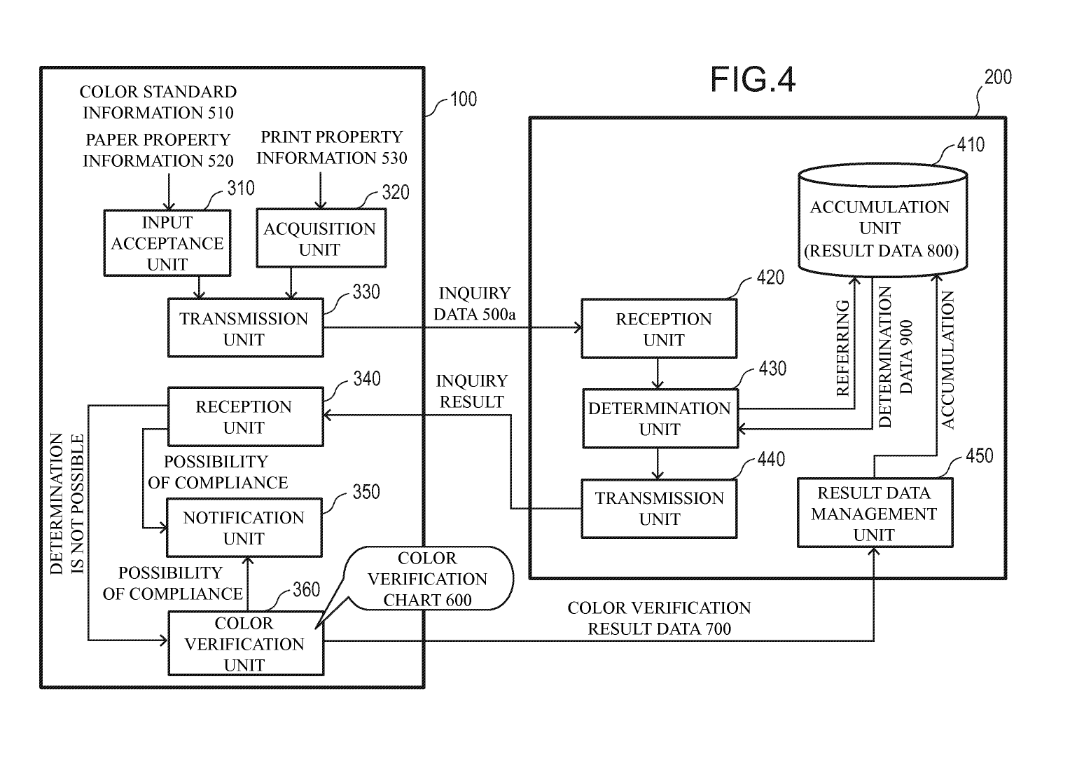

FIG. 4 is a block diagram showing a functional configuration example (a first embodiment) of the information processing system.

### (1) Printing Apparatus 100 (Functional Configuration)

As shown in FIG. 4, the printing apparatus 100 has an input acceptance unit 310, an acquisition unit 320, a transmission unit 330, a reception unit 340, a notification unit 350, and a color verification unit 360.

The input acceptance unit 310 accepts the input of color standard information 510 and paper property information 520. The color standard information 510 is information for designating a standard of a print color and in detail, is information indicating the type of the standard of the print color. An example of the type of the standard includes “Japan Color”, “SWOP”, etc. Furthermore, the paper property information 520 is information indicating the property of a print paper to be used in printing in the printing apparatus 100. For example, the paper property information 520 includes information indicating a paper brand. An example of the information indicating the paper brand includes “POP Closs”, “POD Matte”, etc.

The acquisition unit 320 acquires print property information 530. The print property information 530 is information indicating the property of the printing apparatus (that is, its own apparatus) 100 intended to perform printing. For example, the print property information 530 includes highest density information 531 indicating the highest density of each color material (C, M, Y, and K) used in printing, and model name information 532 indicating a model name of the printing apparatus (that is, its own apparatus) 100 intended to perform printing. An example of the model name information 532 includes “Color PRESS 1070”, “Color PRESS 1100”, etc.

The transmission unit 330 inquires of the server 200 about whether printing complying with a designated standard is possible in the printing apparatus (that is, its own apparatus) 100. In detail, the transmission unit 330 transmits inquiry data 500a to the server 200. In addition, the inquiry data 500a includes the color standard information 510 and the paper property information 520 input to the input acceptance unit 310, and the print property information 530 acquired in the acquisition unit 320. Details of the inquiry data 500a will be described later.

The reception unit 340 receives an inquiry result from the server 200. In detail, the reception unit 340 receives a determination result (data) of the server 200 regarding whether printing complying with the designated standard is possible in the printing apparatus (that is, its own apparatus) 100.

The notification unit 350 notifies a user of the determination result determined by the server 200 (mainly, a determination unit 430 to be described later), that is, the determination result regarding whether printing complying with the designated standard is possible in the printing apparatus 100. In detail, the notification unit 350 displays the determination result received in the reception unit 340 on the display (not shown) of the operating panel unit 120. However, the present invention is not limited thereto, and the notification unit 350 may also display the determination result on a display (for example, a display connected to a computer when a print job has been transmitted to the printing apparatus 100) connected to be able to communicate with the printing apparatus 100. Furthermore, the notification unit 350 may also perform the notification by using sound, vibration, etc.

The color verification unit 360 performs a color verification process when the server 200 is not able to determine whether printing complying with the designated standard is possible in the printing apparatus 100. In detail, the color verification unit 360 prints a color verification chart 600 including a plurality of patches with different colors and densities and measures a color of a print result by the color measurement unit 150. The color verification unit 360 compares a color measurement result (a color value) by the color measurement unit 150 with a reference value registered in advance in each patch, and determines whether printing complying with the designated standard is possible. Furthermore, the color verification unit 360 provides the server 200 with the print result (in detail, color verification result data 700) of the color verification chart 600. Details of the color verification chart 600 and the color verification result data 700 will be described later.

In addition, the input acceptance unit 310 is realized when the CPU 111 reads the program installed in the storage 113 to the memory 112, executes the program, and controls the operating panel unit 120, etc. Furthermore, the acquisition unit 320 is realized when the CPU 111 reads the program installed in the storage 113 to the memory 112, executes the program, and controls the print engine 130, the color measurement unit 150, etc. Furthermore, the transmission unit 330 and the reception unit 340 are realized when the CPU 111 reads the program installed in the storage 113 to the memory 112, executes the program, and controls the external I/F 140, etc. Furthermore, the notification unit 350 is realized when the CPU 111 reads the program installed in the storage 113 to the memory 112, executes the program, and controls the operating panel unit 120 (or the external I/F 140), etc. Furthermore, the color verification unit 360 is realized when the CPU 111 reads the program installed in the storage 113 to the memory 112, executes the program, and controls the print engine 130, the color measurement unit 150, etc.

However, the present invention is not limited thereto, and each of the functional units 310, 320, 330, 340, 350, and 360 may also be realized by hardware such as ASIC (Application Specific Integrated Circuit).

### (2) Server 200 (Functional Configuration)

The server 200 has an accumulation unit 410, a reception unit 420, the determination unit 430, a transmission unit 440, and a result data management unit 450.

The accumulation unit 410 accumulates a result of printing (in detail, printing of the color verification chart) performed in the printing apparatus 100, particularly, information on colors, as print result data 800. Details of the result data 800 will be described later.

The reception unit 420 receives an inquiry from the printing apparatus 100. In detail, the reception unit 420 receives the inquiry data 500a transmitted from the transmission unit 330 of the printing apparatus 100.

The determination unit 430 determines whether printing complying with the designated standard is possible in the printing apparatus 100, on the basis of the inquiry from the printing apparatus 100. In detail, the determination unit 430 refers each piece of information 510, 520, and 530, which is included in the inquiry data 500a received in the reception unit 420, to the result data 800 of the accumulation unit 410, and determines whether printing complying with the standard based on the color standard information 510 is possible. At this time, when the determination unit 430 determines whether printing complying with the standard is possible, by using all pieces of data included in the result data 800, load applied to the server 200 becomes large. Therefore, the determination unit 430 extracts required minimum data (determination data 900) from the result data 800, and then determines whether printing complying with the standard is possible. A detailed determination method will be described later. Furthermore, details of the determination data 900 will also be described later.

The transmission unit 440 notifies the printing apparatus 100 of a result (an inquiry result) for the inquiry from the printing apparatus 100. In detail, the transmission unit 440 transmits, to the printing apparatus 100, the determination result (data) determined by the determination unit 430, that is, the determination result regarding whether printing complying with the designated standard is possible in the printing apparatus 100.

The result data management unit 450 manages the result data 800 accumulated in the accumulation unit 410. In detail, the result data management unit 450 accumulates, in the accumulation unit 410, the print result (in detail, the color verification result data 700) of the color verification chart provided from the color verification unit 360 of the printing apparatus 100.

In addition, the accumulation unit 410 is realized by the storage 213 and the memory 212. Furthermore, the reception unit 420, the transmission unit 440, and the result data management unit 450 are respectively realized when the CPU 211 reads the program installed in the storage 213 to the memory 212, executes the program, and controls the external I/F 240, etc. Furthermore, the determination unit 430 is realized when the CPU 211 reads the program installed in the storage 213 to the memory 212 and executes the program.

However, the present invention is not limited thereto, and the functional units 420, 430, 440, and 450 may also be realized by hardware such as ASIC.

### [Operation of Information Processing System 10]

Next, characteristic operations of the information processing system 10 according to the first embodiment will be described.

### (1-1) Compliance Notification Process

FIG. 5 is a flowchart of the compliance notification process (the first embodiment). The compliance notification process is a process for notifying a user of whether printing complying with a designated standard is possible before printing. In addition, the compliance notification process according to the first embodiment is performed in the printing apparatus 100.

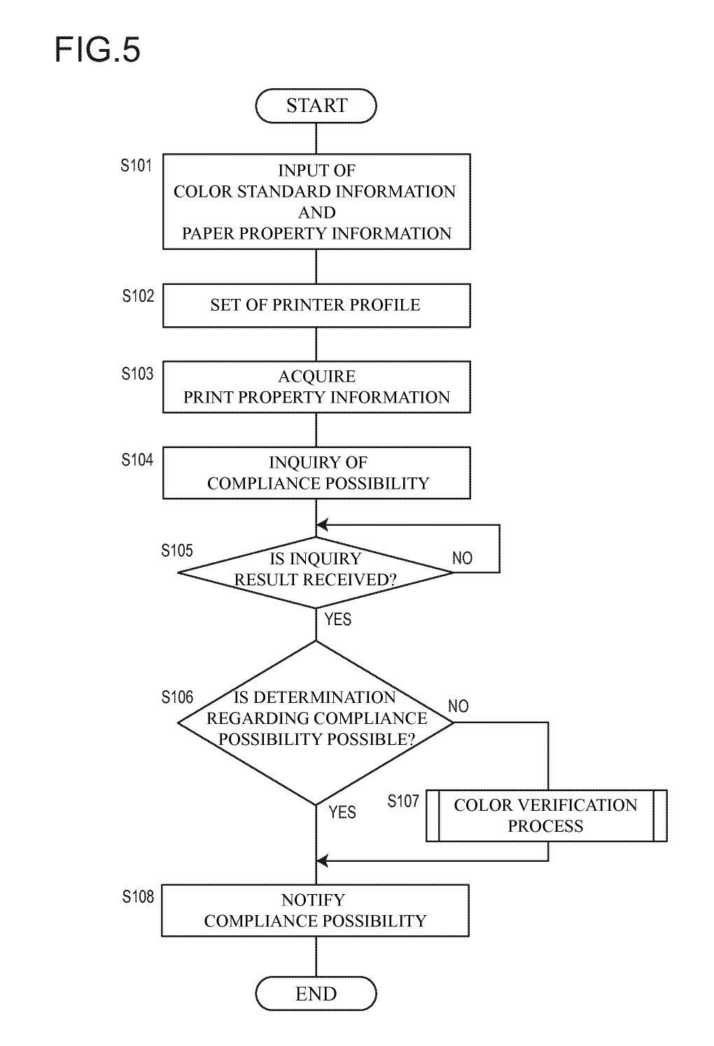

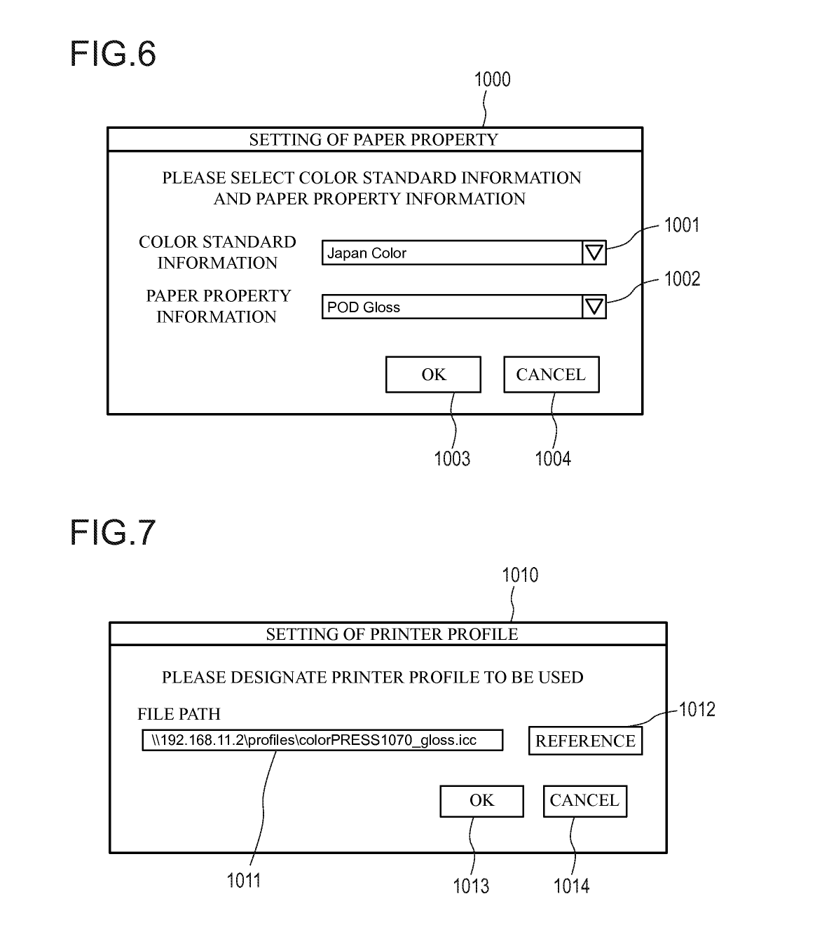

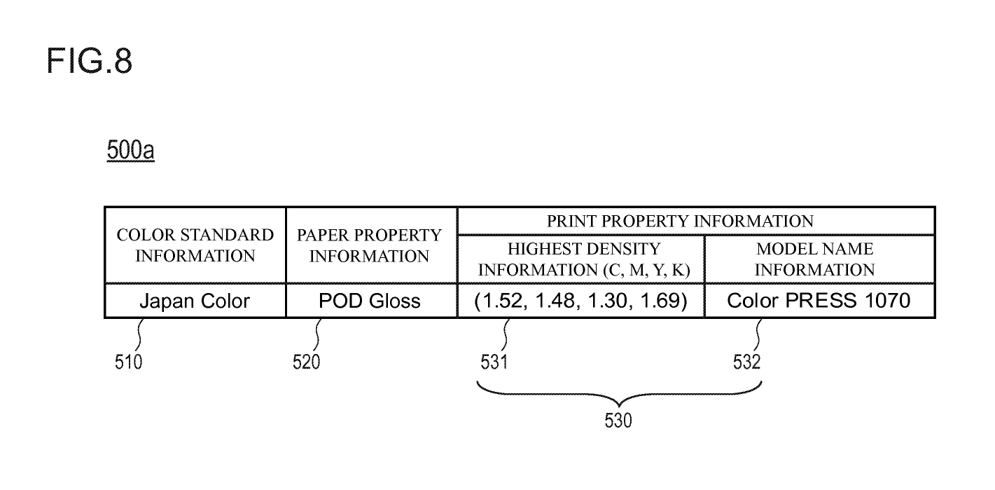

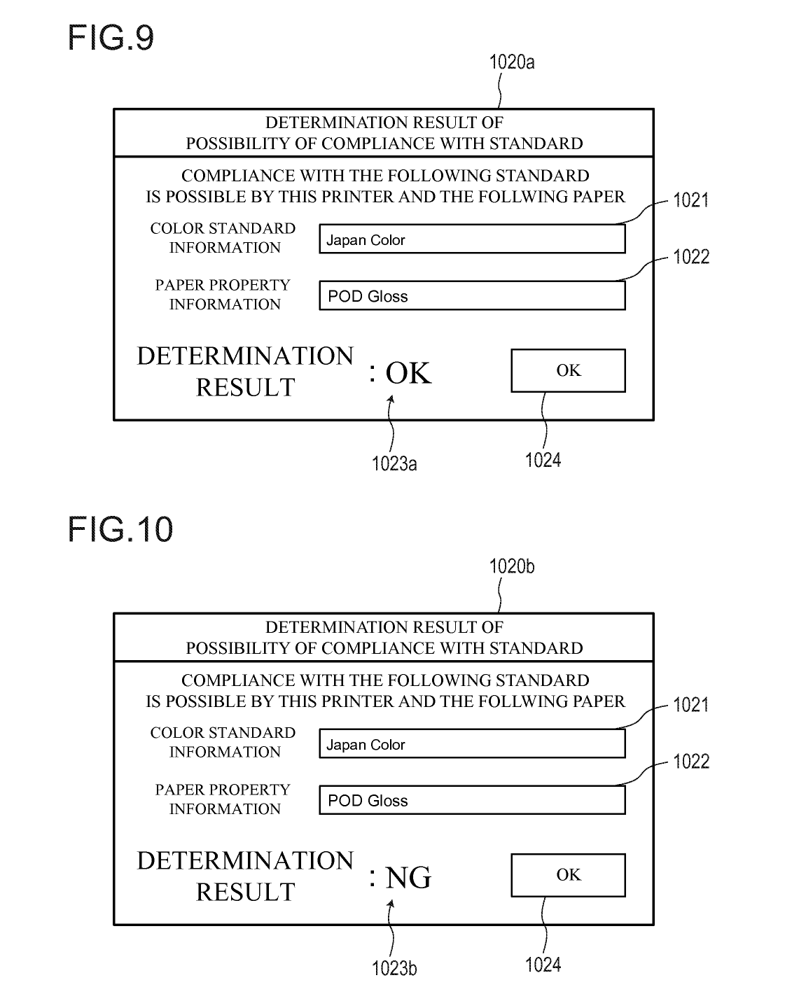

Furthermore, FIG. 6 is a diagram showing a display example of a first input screen. FIG. 7 is a diagram showing a display example of a second input screen. FIG. 8 is a diagram showing a schematic data structure example (the first embodiment) of inquiry data. FIG. 9 is a diagram showing a first display example of a notification screen. FIG. 10 is a diagram showing a second display example of a notification screen.

Hereinafter, with reference to FIG. 5 to FIG. 10, a procedure of the compliance notification process according to the first embodiment will be described.

When an instruction for inquiring of the server 200 about whether printing complying with the designated standard is possible is received on a printing setting screen, etc., the control device 110 of the printing apparatus 100 starts the compliance notification process. The printing setting screen may also be displayed on a display (hereinafter, referred to as an “external display”) connected to a computer (not shown) in which a printer driver has been installed, or may also be displayed on the operating panel unit 120 of the printing apparatus 100.

### (Step S101)

When the compliance notification process is started, the printing apparatus 100 serves as the input acceptance unit 310 and accepts the input of the color standard information 510 and the paper property information 520. In detail, the printing apparatus 100 displays a first input screen 1000 as shown in FIG. 6 on the external display (not shown) or the operating panel unit 120, and accepts an operation of a user.

The first input screen 1000 is a screen for inputting the color standard information 510 and the paper property information 520. In detail, the first input screen 1000 is provided with a first selection box 1001 for selecting the color standard information (for example, the type of a standard regarding print colors) 510 and a second selection box 1002 for selecting the paper property information (for example, a paper brand) 520. Moreover, the first input screen 1000 is provided with an OK button 1003 for deciding the content selected in each of the selection boxes 1001 and 1002 and a cancel button 1004 for canceling the input of the color standard information 510 and the paper property information 520.

When a user performs an operation for touching the OK button 1003, the printing apparatus 100 decides the content selected in the first selection box 1001 as the designated color standard information 510. In addition, the printing apparatus 100 decides the content selected in the second selection box 1002 as the paper property information 520 on a print paper to be used in printing.

### (Step S102)

The printing apparatus 100 serves as the input acceptance unit 310 and accepts the input of a printer profile. In detail, the printing apparatus 100 displays a second input screen 1010 as shown in FIG. 7 on the external display (not shown) or the operating panel unit 120, and accepts an operation of a user.

The second input screen 1010 is a screen for setting a printer profile to be used in printing. In detail, the second input screen 1010 is provided with an input box 1011 for inputting a path (a storage place) of the printer profile to be used in printing and a reference button 1012 for displaying a dialogue box, etc., for searching for the printer profile. Moreover, the second input screen 1010 is provided with an OK button 1013 for deciding the content selected in the input box 1011 and a cancel button 1014 for canceling the input of the printer profile.

When a user performs an operation for touching the OK button 1013, the printing apparatus 100 sets the printer profile specified by the path input to the input box 1011 as the printer profile to be used in printing.

In addition, the printer profile is a look-up table that converts a device-independent color space to a color space unique to the printing apparatus 100.

### (Step S103)

The printing apparatus 100 serves as the acquisition unit 320 and acquires the print property information 530 which is information indicating properties of its own apparatus. In detail, the printing apparatus 100 acquires, as the print property information 530, the highest density information 531 of each color material (C, M, Y, and K) used in printing, and the model name information 532 of the printing apparatus (that is, its own apparatus) 100 intended to perform printing. The highest density information 531 of each color material is acquired by transferring (printing) each color material on a print paper with a density available in the print engine 130 and measuring a color of the print result by the color measurement unit 150. Furthermore, the model name information 532 is acquired by reading information (information indicating a model name) stored in the storage 113, etc., to the memory 112.

### (Step S104)

The printing apparatus 100 serves as the transmission unit 330 and inquires of the server 200 about whether printing complying with the designated standard is possible. In detail, the printing apparatus 100 transmits the inquiry data 500a according to the first embodiment as shown in FIG. 8 to the server 200. In the inquiry data 500a, the color standard information 510 and the paper property information 520 input in step S101 and the print property information 530 acquired in step S103 are associated with each other.

### (Step S105)

The printing apparatus 100 serves as the reception unit 340 and determines whether an inquiry result from the server 200 has been received. The inquiry result includes information indicating whether printing complying with the designated standard is possible, etc. When the inquiry result has not been received (step S105: NO), the printing apparatus 100 waits until the inquiry result is received from the server 200. On the other hand, when the inquiry result has been received (step S105: YES), the printing apparatus 100 allows the procedure to proceed to step S106.

### (Step S106)

The printing apparatus 100 serves as the reception unit 340 and determines whether it is possible to determine whether printing complying with the designated standard is possible, on the basis of the inquiry result received in step S105. In detail, when the inquiry result is “compliance is possible” or “compliance is not possible”, the printing apparatus 100 determines that it is possible to determine whether printing complying with the designated standard is possible. On the other hand, when the inquiry result is “determination is not possible”, the printing apparatus 100 determines that it is not possible to determine whether printing complying with the designated standard is possible.

When it is determined that the determination is possible in step S106 (step S106: YES), the printing apparatus 100 notifies the notification unit 350 of the inquiry result and allows the procedure to proceed to step S108. On the other hand, when it is determined that the determination is not possible in step S106 (step S106: NO), the printing apparatus 100 notifies the color verification unit 360 of the inquiry result and allows the procedure to proceed to step S107.

### (Step S107)

The printing apparatus 100 serves as the color verification unit 360 and performs a color verification process according to the first embodiment. The color verification process is a process for verifying whether printing complying with the designated standard is possible in the current state (condition) of the printing apparatus 100. The printing apparatus 100 performs the color verification process, so that it is possible to independently determine whether printing complying with the designated standard is possible even when a result (the result data 800) printed under the same condition in the past has not been accumulated in the server 200. Details of the color verification process according to the first embodiment will be described later.

After the color verification process of step S107 is completed, the printing apparatus 100 allows the procedure to proceed to step S108.

### (Step S108)

The printing apparatus 100 serves as the notification unit 350 and notifies a user of the inquiry result from the server 200, that is, the determination result by the server 200 regarding whether printing complying with the designated standard is possible in its own apparatus. Furthermore, when the color verification process has been performed in step S107, the printing apparatus 100 notifies a user of the determination result of the color verification process. In detail, the printing apparatus 100 selectively displays a notification screen 1020a of a first display example as shown in FIG. 9 or a notification screen 1020b of a second display example as shown in FIG. 10 on the external display (not shown) or the operating panel unit 120.

For example, when it is determined that printing complying with the designated standard is possible (compliance is possible), the printing apparatus 100 displays the notification screen 1020a of the first display example. On the other hand, when it is determined that printing complying with the designated standard is not possible (compliance is not possible), the printing apparatus 100 displays the notification screen 1020b of the second display example.

The notification screen 1020a of the first display example is a screen for notifying a user that printing complying with the designated standard is possible (compliance is possible). In detail, the notification screen 1020a of the first display example is provided with a first column 1021 for displaying the designated color standard information 510 and a second column 1022 for displaying the paper property information 520 on a print paper to be used in printing. Moreover, on the notification screen 1020a of the first display example, a character string (may also be an image) 1023a for notifying a user that printing complying with the designated standard is possible in its own apparatus is displayed. Moreover, the notification screen 1020a of the first display example is provided with an OK button 1024 for preventing the screen 1020a from being displayed when the user has confirmed the notification content.

The notification screen 1020b of the second display example is a screen for notifying a user that printing complying with the designated standard is not possible (compliance is not possible). In detail, on the notification screen 1020b of the second display example, a character string (may also be an image) 1023b for notifying a user that printing complying with the designated standard is not possible in its own apparatus is displayed, differently from the notification screen 1020a of the first display example.

The process of step S108 is ended, the printing apparatus 100 ends the compliance notification process according to the first embodiment.

The aforementioned compliance notification process is performed, so that it is possible to notify a user of whether printing complying with the designated standard is possible in the printing apparatus 100. Since this notification is performed before printing, a user can stop printing if printing complying with the designated standard is not possible, thereby reducing the generation of waste papers.

### (1-2) Color Verification Process

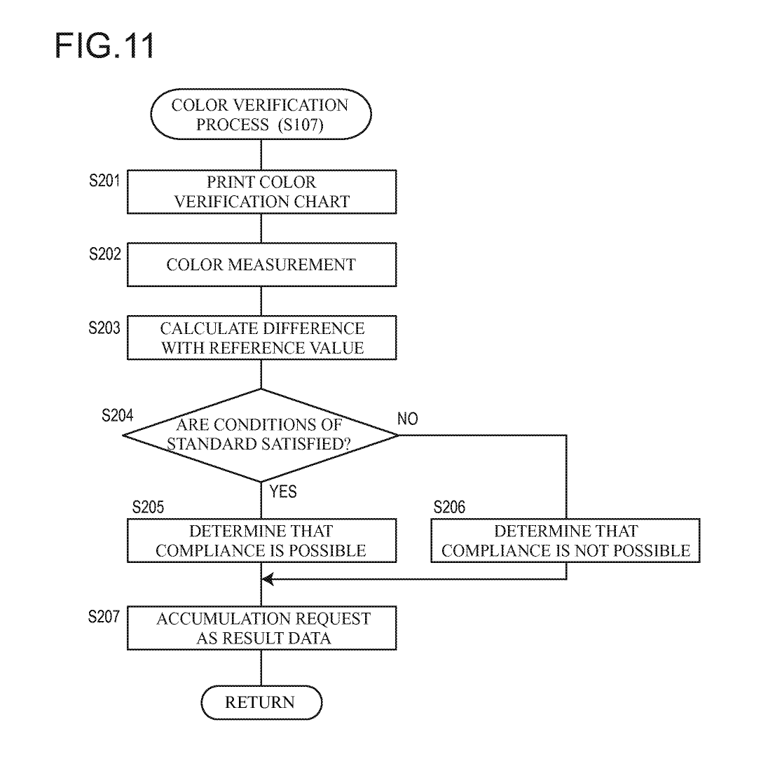

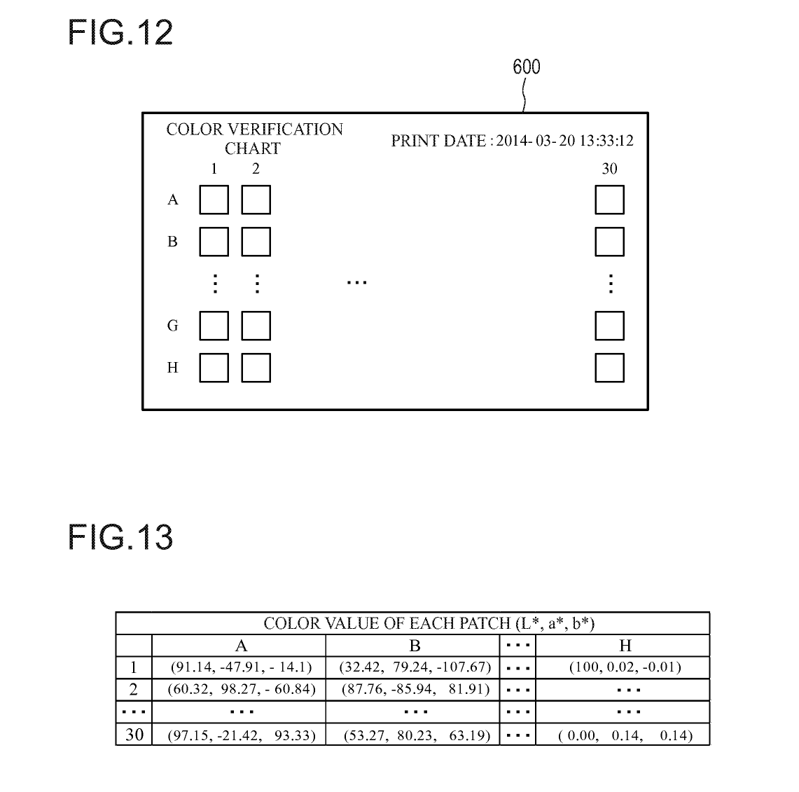

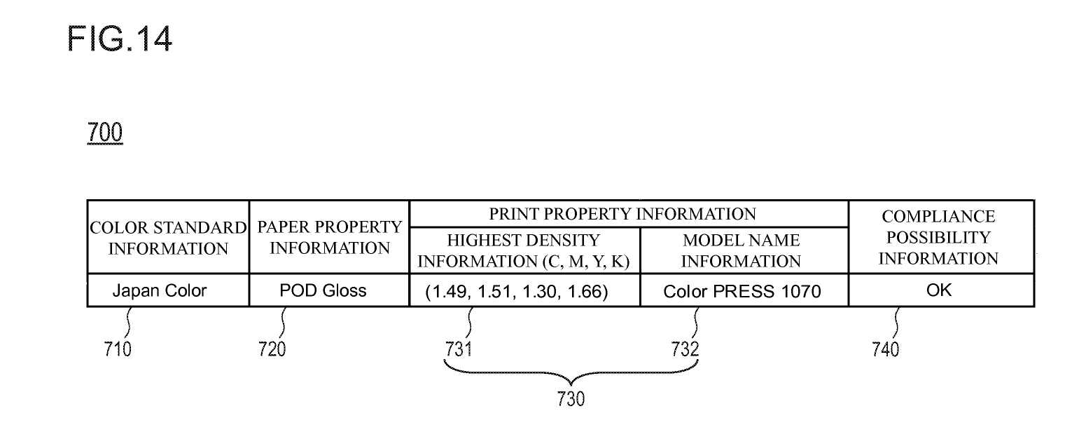

FIG. 11 is a flowchart of the color verification process. FIG. 12 is a diagram showing a schematic data structure example of the color verification chart. FIG. 13 is a diagram showing an example of a reference value registered in advance as a color value of each patch constituting the color verification chart. FIG. 14 is a diagram showing a schematic data structure example (the first embodiment) of the color verification result data.

Hereinafter, with reference to FIG. 11 to FIG. 14, a procedure of the color verification process will be described.

The control device 110 of the printing apparatus 100 starts the color verification process when the procedure proceeds to step S107 of the aforementioned compliance notification process.

### (Step S201)

When the color verification process is started, the printing apparatus 100 serves as the color verification unit 360 and prints the color verification chart 600. In detail, the printing apparatus 100 reads the color verification chart 600 from the storage 113, etc., and converts the color verification chart 600 to a color space unique to the printing apparatus 100 by using the printer profile set in step S102, etc. Then, the printing apparatus 100 controls the print engine 130 to print the color verification chart 600 with the converted color space on a print paper having the property of the color standard information (for example, a paper brand) 520 input in step S101. In addition, the color verification chart 600 includes a plurality of patches (for example, 8 row×30 columns) in which colors and densities are different from one another as shown in FIG. 12.

### (Step S202)

The printing apparatus 100 serves as the color verification unit 360 and measures a color of a print result of the color verification chart 600 by the color measurement unit 150. For example, the printing apparatus 100 performs color measurement by using a spectrophotometer in each patch constituting the color verification chart 600, and converts a color measurement result into a color value (L*, a*, and b*) and a density.

### (Step S203)

The printing apparatus 100 serves as the color verification unit 360, compares the color measurement result (a color value) by the color measurement unit 150 obtained in step S202 with a reference value (a color value) registered in advance in each patch, and calculates a difference therebetween. In addition, as the reference value, a color value (L*, a*, and b*) corresponding to colors of each patch of the color verification chart 600 has been registered in advance as shown in FIG. 13.

### (Step S204)

The printing apparatus 100 serves as the color verification unit 360 and determines whether conditions of the designated standard (the standard based on the color standard information 510 input in step S101) are satisfied. For example, in each patch constituting the color verification chart 600, the printing apparatus 100 employs the color value of the color measurement unit and the color value of the reference value as points in a three-dimensional space of L*, a*, and b*, and calculates an Euclidean distance thereof. Furthermore, in all the patches, when the calculated Euclidean distance is smaller than a predetermined threshold value, the printing apparatus 100 determines that the conditions of the designated standard are satisfied. On the other hand, in at least one patch, when the calculated Euclidean distance is equal to or more than the predetermined threshold value, the printing apparatus 100 determines that the conditions of the designated standard are not satisfied. In addition, the predetermined threshold value is a value decided by the designated standard.

When it is determined that the conditions of the designated standard are satisfied (step S204: YES), the printing apparatus 100 allows the procedure to proceed to step S205. On the other hand, when it is determined that the conditions of the designated standard are not satisfied (step S204: NO), the printing apparatus 100 allows the procedure to proceed to step S206.

### (Step S205)

The printing apparatus 100 serves as the color verification unit 360 and determines that printing complying with the designated standard is possible.

### (Step S206)

The printing apparatus 100 serves as the color verification unit 360 and determines that printing complying with the designated standard is not possible.

### (Step S207)

The printing apparatus 100 serves as the color verification unit 360 and requests the server 200 to accumulate the determination result of step S205 or step S206 as the result data 800 (hereinafter, referred to as an “accumulation request”). In detail, the printing apparatus 100 transmits, to the server 200, the color verification result data 700 shown in FIG. 14 in which color standard information 710, paper property information 720, print property information 730, and compliance possibility information 740 have been associated with one another.

The color standard information 710, the paper property information 720, and the print property information (including highest density information 731 and model name information 732) 730 is information respectively corresponding to the color standard information 510, the paper property information 520, and the print property information 530 of the inquiry data 500a. Furthermore, the compliance possibility information 740 is information configured by a character string such as “OK” or “NG”. The “OK” indicates that the printing performed in step S201 complies with the designated standard and is generated when the determination of step S205 has been performed. The “NG” indicates that the printing performed in step S201 does not comply with the designated standard and is generated when the determination of step S206 has been performed.

When the process of step S207 is ended, the printing apparatus 100 ends the color verification process and returns the procedure to the compliance notification process.

The aforementioned color verification process is performed, so that whether printing complying with the designated standard is possible can be determined in the printing apparatus 100 even though a result (the result data 800) printed under the same condition in the past has not been accumulated in the server 200.

### (1-3) Result Data Accumulation Process

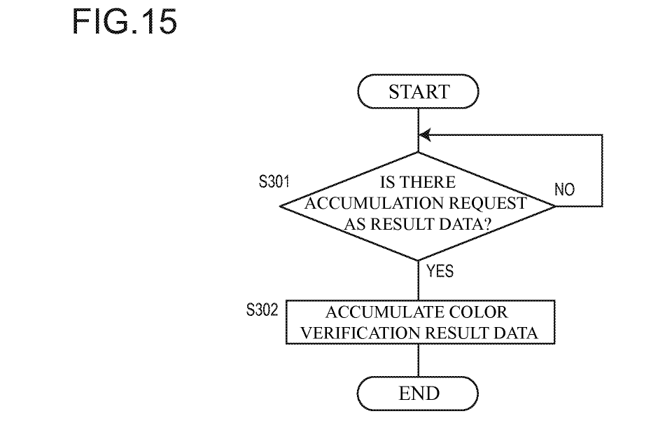

FIG. 15 is a flowchart of the result data accumulation process. The result data accumulation process is a process in which the result of the printing performed in the printing apparatus 100 is accumulated as a result. In addition, the result data accumulation process is performed in the server 200.

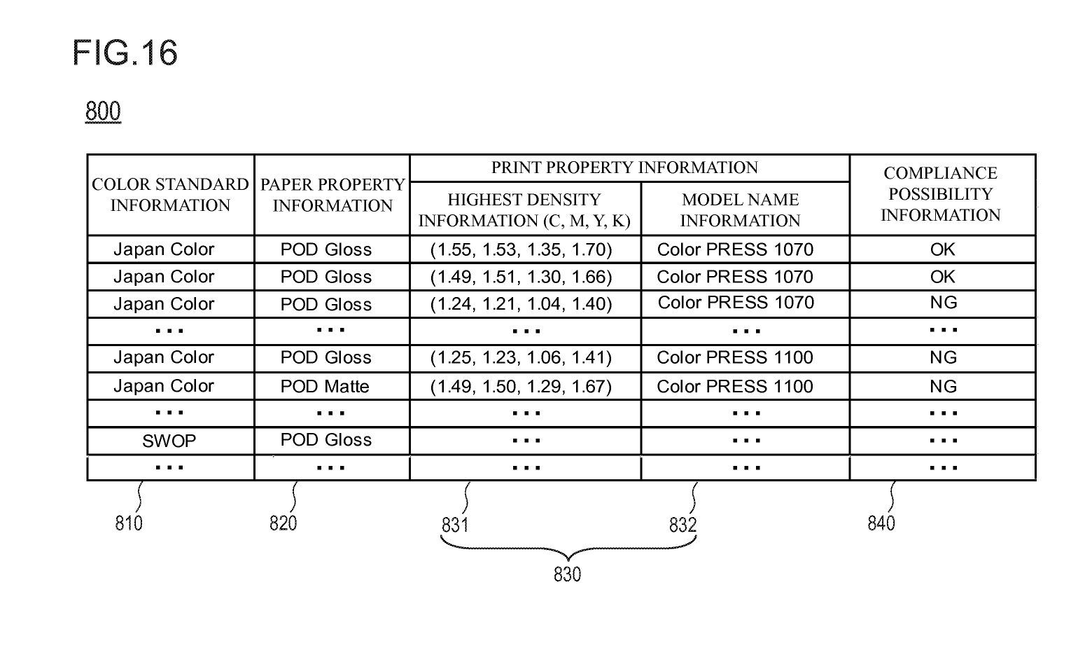

Furthermore, FIG. 16 is a diagram showing a schematic data structure example (the first embodiment) of accumulation data.

Hereinafter, with reference to FIG. 15 and FIG. 16, a procedure of the result data accumulation process will be described.

The control device 210 of the server 200 starts the result data accumulation process when the server 200 is powered on.

### (Step S301)

When the result data accumulation process is started, the server 200 serves as the result data management unit 450 and determines the presence or absence of an accumulation request from the printing apparatus 100. In detail, the result data management unit 450 determines the presence or absence of the accumulation request according to whether the color verification result data 700 transmitted from the printing apparatus 100 has been received.

When the color verification result data 700 has not been received, the server 200 determines that there is no accumulation request from the printing apparatus 100 (step S301: NO) and waits until there is the accumulation request. On the other hand, when the color verification result data 700 has been received, the server 200 determines that there is the accumulation request from the printing apparatus 100 (step S301: YES) and allows the procedure to proceed to step S302.

### (Step S302)

The server 200 serves as the result data management unit 450 and accumulates the color verification result data 700 in the accumulation unit 410. In detail, the server 200 associates the color standard information 710, the paper property information 720, the print property information 730, and the compliance possibility information 740, which are included in the color verification result data 700, with one record, thereby accumulating them as the accumulated data 800.

### (Result Data 800 According to First Embodiment)

In addition, the accumulated data 800 accumulated in the accumulation unit 410 is as follows.

As shown in FIG. 16, the result data 800 according to first embodiment has a data structure in which color standard information 810, paper property information 820, print property information 830, and compliance possibility information 840 have been associated with one another.

The color standard information 810 is information corresponding to the color standard information 710 of the color verification result data 700. Consequently, the color standard information 810 is information indicating the type of the standard designated in the printing apparatus 100 having performed the printing (the printing of the color verification chart 600), and is configured by a character string such as “Japan Color” and “SWOP”.

The paper property information 820 is information corresponding to the paper property information 720 of the color verification result data 700. Consequently, the paper property information 820 is information indicating the property of the print paper used in the printing apparatus 100 having performed the printing (the printing of the color verification chart 600), and is configured by a character string indicating a paper brand such as “POD Closs” and “POD Matte”.

The print property information 830 is information corresponding to the print property information 730 of the color verification result data 700. The print property information 830 is information indicating the property of the printing apparatus 100 when the printing apparatus 100 has performed the printing (the printing of the color verification chart 600), and includes highest density information 831 indicating the highest density of each color material (C, M, Y, and K) used in the printing and model name information 832 indicating a model name of the printing apparatus 100 having performed the printing. The model name information 832 is configured by a character string such as “Color PRESS 1070” and “Color PRESS 1100”.

The compliance possibility information 840 is information corresponding to the compliance possibility information 740 of the color verification result data 700. The compliance possibility information 840 is information indicating whether the printing (the printing of the color verification chart 600) performed in the printing apparatus 100 complies with the designated standard (the standard based on the color standard information 810). An example of the compliance possibility information 840 includes “OK” indicating that the printing complies with the designated standard, “NG” indicating that the printing does not comply with the designated standard, etc.

When only one type of standard (for example, “Japan Color”) can be designated in the printing apparatus 100, the color standard information 810 may not be included in the result data 800. Consequently, it can be said that the result data 800 according to the first embodiment is data in which the compliance possibility information 840 is accumulated in each combination of at least the paper property information 820 and the print property information 830.

After the process of step S302 is ended, the server 200 ends the result data accumulation process.

The aforementioned result data accumulation process is performed, so that the server 200 can accumulate a result (information regarding whether printing complies with the designated standard) of the printing whenever the printing (the printing of the color verification chart 600) is performed in the printing apparatus 100.

### (1-4) Compliance Determination Process

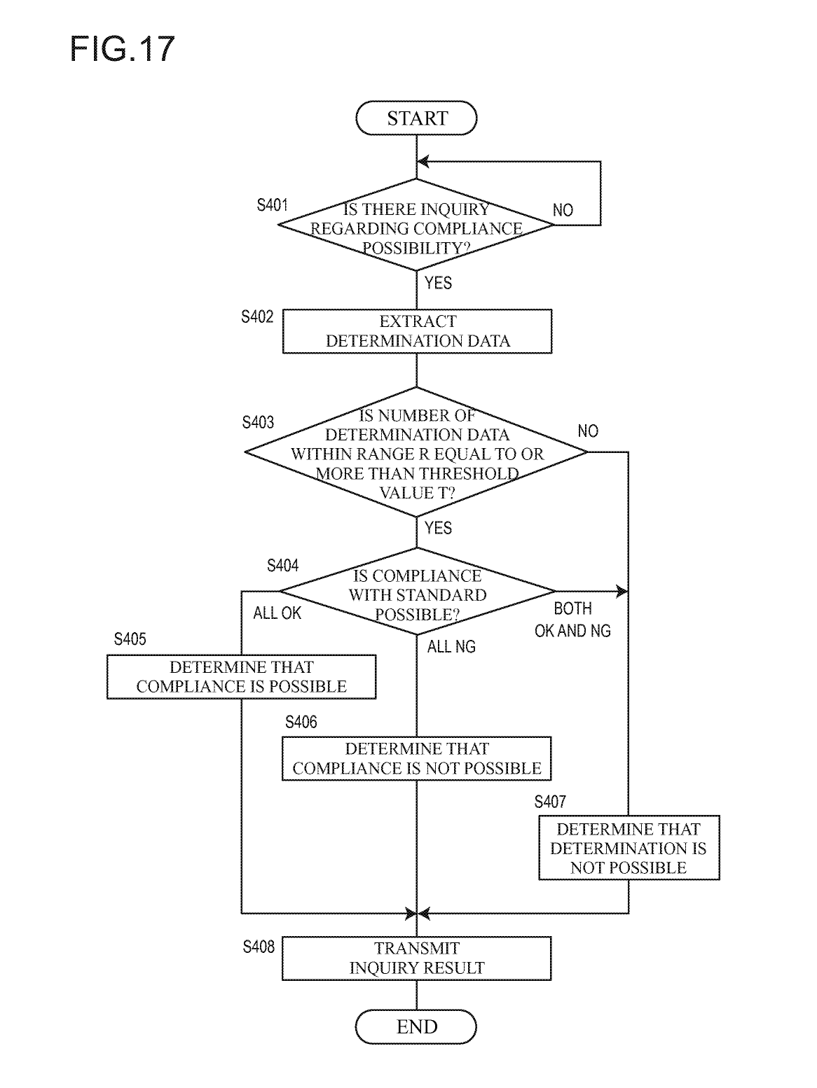

FIG. 17 is a flowchart of the compliance determination process. The compliance determination process is a process in which printing complying with the designated standard is possible in the printing apparatus 100 in response to an inquiry from the printing apparatus 100. In addition, the compliance determination process is performed in the server 200.

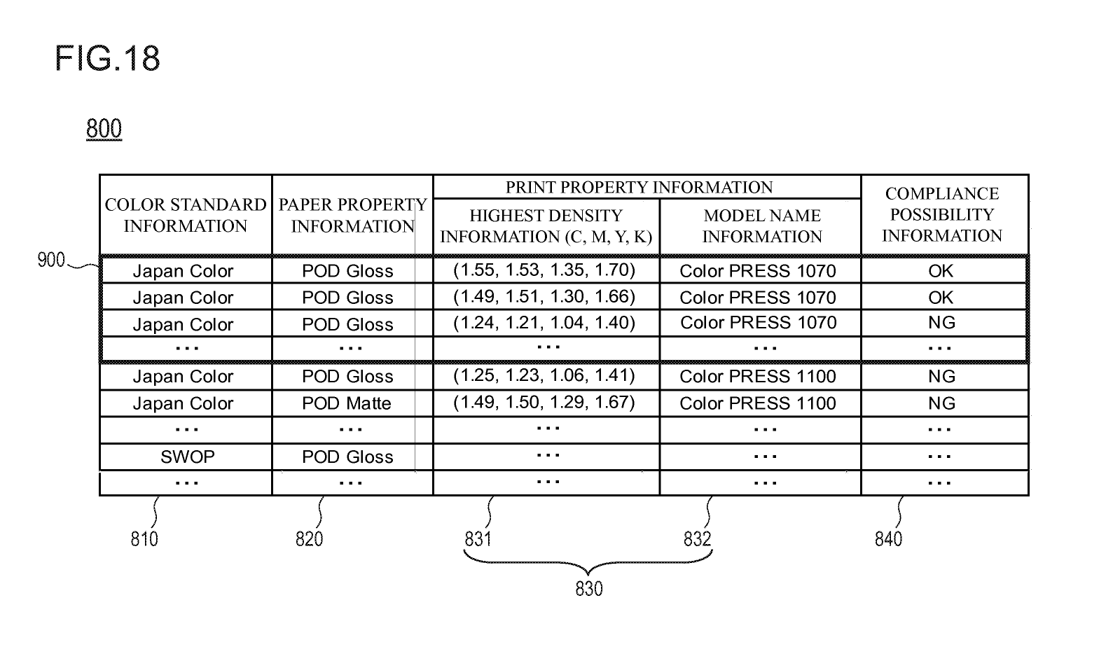

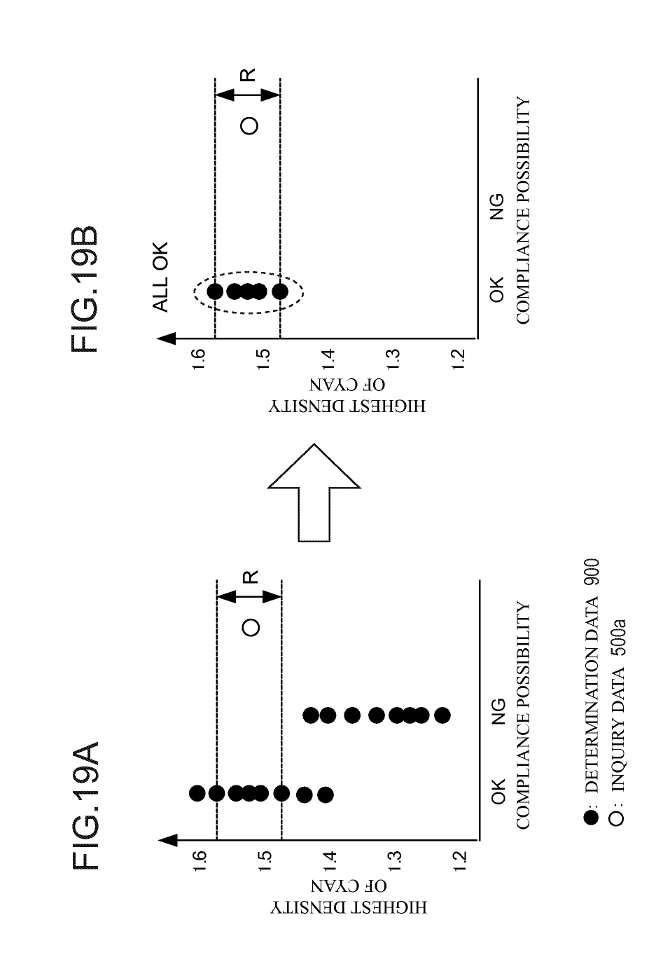

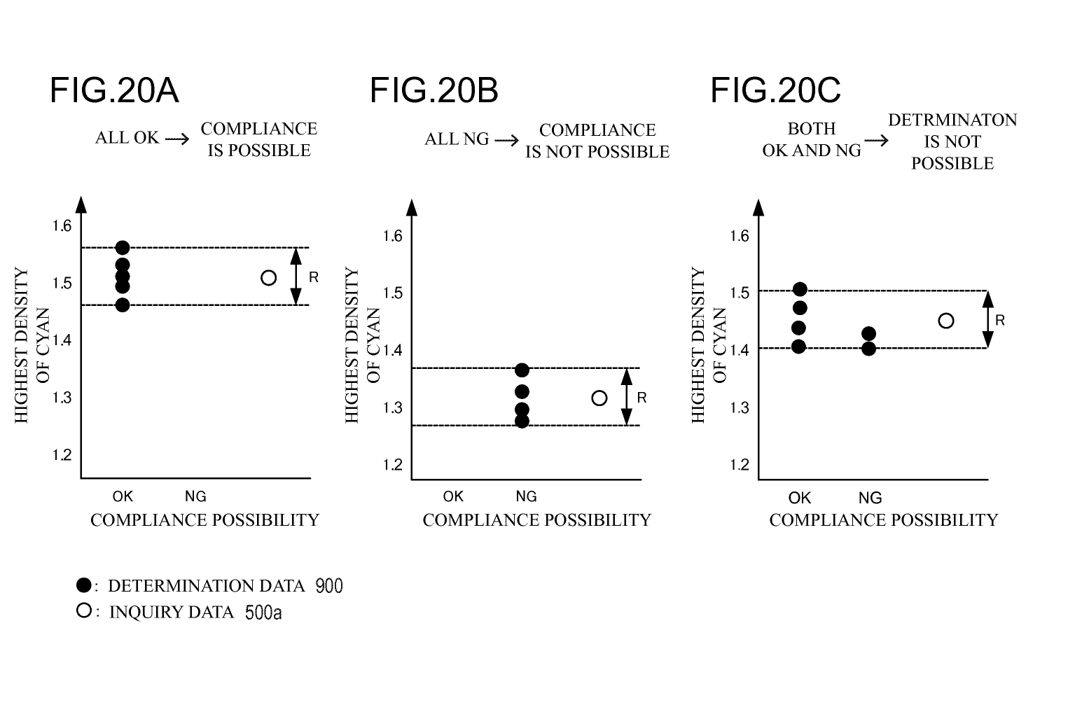

Furthermore, FIG. 18 is a diagram for explaining an extraction method (the first embodiment) of determination data. FIG. 19 is a diagram for explaining a method (the first embodiment) for determining compliance with a standard by using the determination data. FIG. 20 is a diagram showing an example when “compliance is possible”, “compliance is not possible”, and “determination is not possible” are determined.

Hereinafter, with reference to FIG. 17 to FIG. 20, a procedure of the compliance determination process will be described.

The control device 210 of the server 200 starts the compliance determination process when the server 200 is powered on.

### (Step S401)

When the compliance determination process is started, the server 200 serves as the reception unit 420 and determines whether there is an inquiry from the printing apparatus 100 regarding whether printing complying with the designated standard is possible. In detail, the server 200 determines the presence or absence of the inquiry from the printing apparatus 100 in response to whether the inquiry data 500a transmitted from the printing apparatus 100 in step S104 has been received.

When the inquiry data 500a has not been received, the server 200 determines that there is no inquiry from the printing apparatus 100 (step S401: NO) and waits until there is the inquiry. On the other hand, when the inquiry data 500a has been received, the server 200 determines that there is the inquiry from the printing apparatus 100 (step S401: YES) and allows the procedure to proceed to step S402.

### (Step S402)

The server 200 serves as the determination unit 430 and extracts minimum determination data 900, which is required for determining whether printing complying with the designated standard is possible, from the accumulated data 800. In detail, the server 200 extracts, as the determination data 900, a record having all pieces of data coinciding with the color standard information 510, the paper property information 520, and the model name information 532 included in the inquiry data 500a received in step S401. For example, in an example shown in FIG. 18, the server 200 extracts, as the determination data 900, a record having all of “Japan Color”, “POD Gloss”, and “Color PRESS 1070” (inside the thick frame).

### (Step S403)

The server 200 serves as the determination unit 430, counts the number of determination data 900 having a value of the highest density information 831 of each color material (C, M, Y, and K) within a predetermined range R among the determination data 900 extracted in step S402, and determines whether the counted number is equal to or more than a threshold value T.

FIG. 19A is a graph obtained by plotting all pieces of determination data 900 with black circles, and FIG. 19B is a graph obtained by plotting only determination data 900 within the predetermined range R with black circles. Furthermore, white circles of FIGS. 19A and 19B indicate the value of the highest density information 531 included in the inquiry data 500a. In all the graphs, a horizontal axis denotes content indicated by the compliance possibility information 840 included in the determination data 900, that is, “compliance is possible (OK)” or “compliance is not possible (NG)”. A vertical axis denotes the value of the highest density information (cyan in the shown example) 831 included in the determination data 900.

In the examples shown in FIGS. 19A and 19B, the highest density information 531 of cyan (C) included in the inquiry data 500a is “1.52”. In this case, the server 200 counts the number of determination data 900 within the predetermined range (for example, a range of 1.47 or more and 1.57 or less) R about the value indicated by the highest density information 531 of cyan (C) included in the inquiry data 500a. In the example shown in FIG. 19B, the number of determination data 900 corresponds to five pieces of determination data 900 surrounded by a circular broken line.

The server 200 performs such counting in each color material (C, M, Y, and K). Furthermore, the server 200 determines whether the counted number of determination data 900 is equal to or more than the threshold value T (for example, five) with respect to all the color materials (C, M, Y, and K), and allows the procedure to proceed to step S404 when the counted number is equal to or more than the threshold value T. On the other hand, when the counted number of determination data 900 is smaller than the threshold value T (for example, five) with respect to at least one color material, the server 200 allows the procedure to proceed to step S407.

### (Step S404)

The server 200 serves as the determination unit 430 and refers to the compliance possibility information 840 of the determination data 900 having the value of the highest density information 831 of each color material (C, M, Y, and K) within the predetermined range R.

FIG. 20A is a diagram showing an example when all the referred compliance possibility information 840 is “compliance is possible (OK)”. When all the referred compliance possibility information 840 is “compliance is possible (OK)” with respect to all the color materials (C, M, Y, and K), the server 200 allows the procedure to proceed to step S405.

FIG. 20B is a diagram showing an example when all the referred compliance possibility information 840 is “compliance is not possible (NG)”. When all the referred compliance possibility information 840 is “compliance is not possible (NG)” with respect to all the color materials (C, M, Y, and K), the server 200 allows the procedure to proceed to step S406. Furthermore, even when all the referred compliance possibility information 840 is “compliance is not possible (NG)” with respect to at least one color material and all the referred compliance possibility information 840 is “compliance is possible (OK)” with respect to the other color materials, the server 200 allows the procedure to proceed to step S406.

FIG. 20C is a diagram showing an example when the referred compliance possibility information 840 is “compliance is possible (OK)” and is “compliance is not possible (NG)”. When the referred compliance possibility information 840 is “compliance is possible (OK)” and is “compliance is not possible (NG)” with respect to at least one color material, the server 200 allows the procedure to proceed to step S407.

### (Step S405)

The server 200 serves as the determination unit 430 and determines that printing complying with the designated standard is possible in the printing apparatus 100 having inquired (compliance is possible).

### (Step S406)

The server 200 serves as the determination unit 430 and determines that printing complying with the designated standard is not possible in the printing apparatus 100 having inquired (compliance is not possible).

### (Step S407)

The server 200 serves as the determination unit 430 and determines that it is not possible to determine whether printing complying with the designated standard is possible in the printing apparatus 100 having inquired (determination is not possible).

### (Step S408)

The server 200 serves as the transmission unit 440 and provides the determination results in step S405 to step S407 to the printing apparatus 100 as inquiry results. That is, the server 200 transmits any one of the “compliance is possible”, the “compliance is not possible”, and the “determination is not possible” to the printing apparatus 100 as the inquiry results (corresponding to step S105).

After the process of step S408 is ended, the server 200 ends the compliance determination process.

The aforementioned the compliance determination process is performed, so that the server 200 can combine the paper property information 520 and the print property information 530 with each other to refer to the past operation result (the result data 800), thereby determining whether compliance with a standard of a print color is possible. When the past operation result exists, even though a color verification chart is printed and colors of a plurality of patches are not measured, it is possible to determine whether the compliance with the standard of the print color is possible and to reduce the generation of waste papers and effort of a user. In addition, since it is determined whether the compliance with the standard of the print color is possible in consideration of the combination of the paper property information 520 and the print property information 530, accurate determination is possible as compared with the case in which only the paper property information 520 is considered.

Furthermore, in step S402, the server 200 extracts required minimum determination data 900 from result data 800 with enormous number of data. Therefore, it is possible to significantly reduce a load of the server 200 applied to the process for determining whether printing complying with the designated standard is possible in the printing apparatus 100.

Furthermore, in step S403, the server 200 counts the number of determination data 900 having the value of the highest density information 831 of each color material (C, M, Y, and K) within the predetermined range R, and determines that determination is not possible when the counted number is small. In this way, the reliability of a determination result determined by the server 200 is improved.

### Second Embodiment

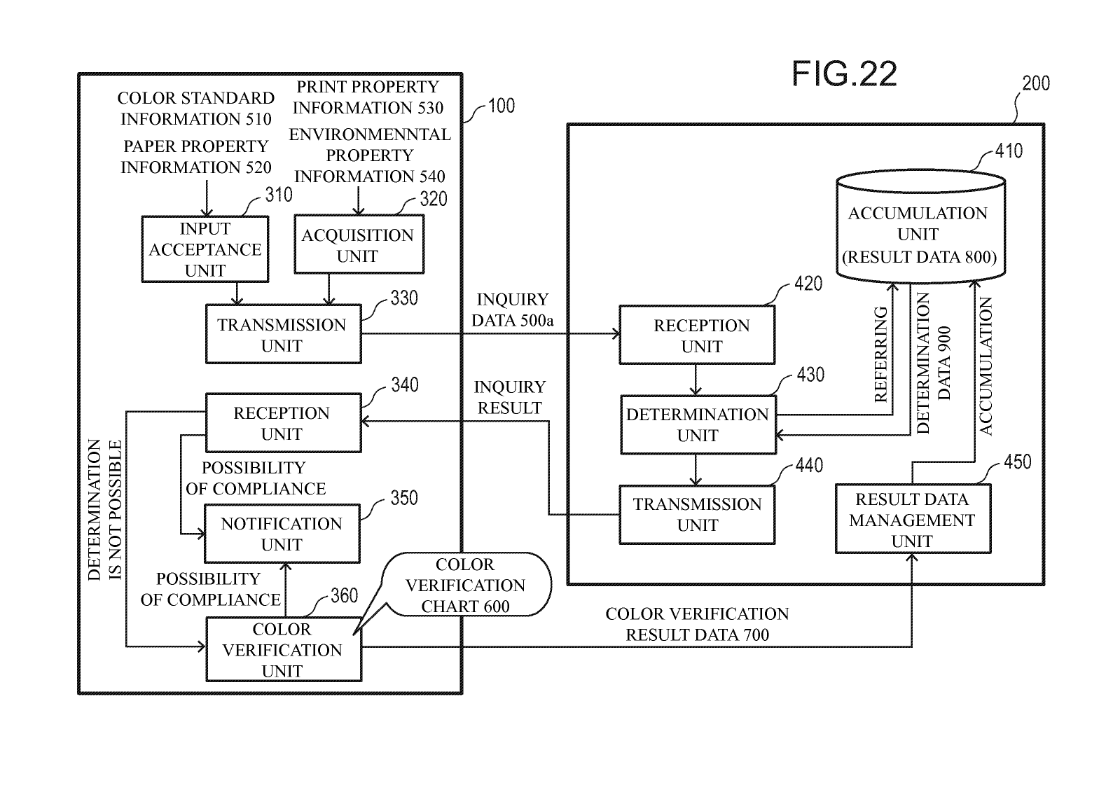

Next, with reference to FIG. 22 to FIG. 33C, a second embodiment of the present invention will be described. However, an information processing system 10 according to the second embodiment will be described while focusing on a difference with the information processing system 10 according to the first embodiment.

### [Printing Apparatus 100 (Hardware Configuration)]

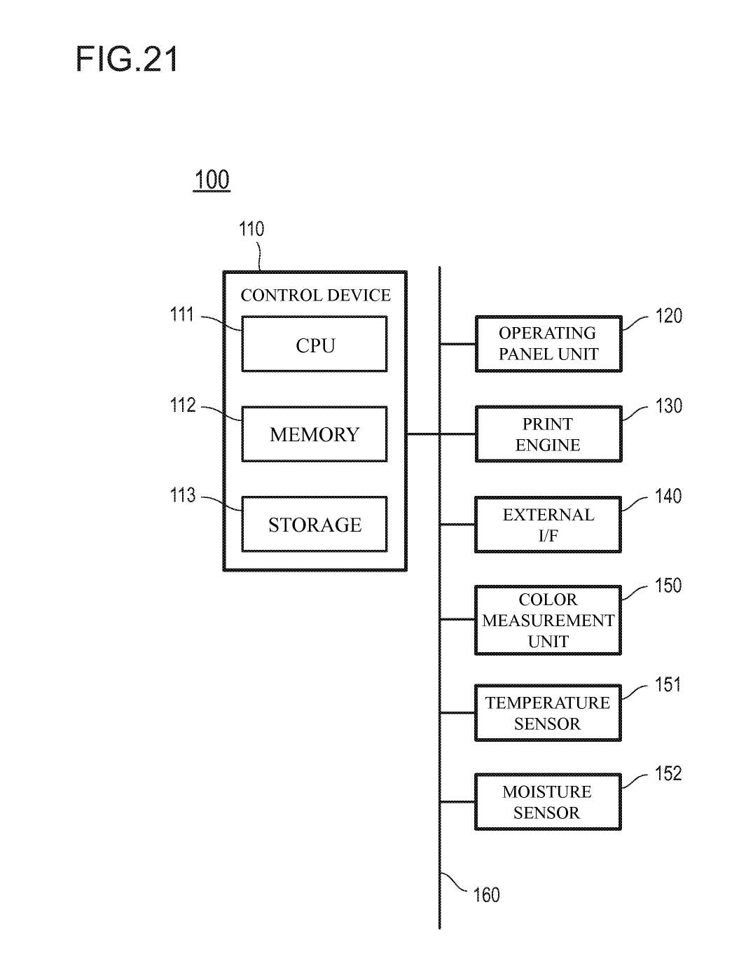

FIG. 21 is a block diagram showing a hardware configuration example (a second embodiment) of a printing apparatus. As shown in FIG. 21, a printing apparatus 100 according to the second embodiment is different from the first embodiment in that a temperature sensor 151 and a moisture sensor 152 are provided.

The temperature sensor 151 is a sensor that measures peripheral temperature of the printing apparatus 100 and converts the temperature into numerical data. For example, the temperature sensor 151 is provided in the vicinity of the print engine 130.

The moisture sensor 152 is a sensor that measures peripheral moisture of the printing apparatus 100 and converts the moisture into numerical data. For example, the moisture sensor 152 is provided in the vicinity of the print engine 130.

### [Information Processing System 10 (Functional Configuration)]

FIG. 22 is a block diagram showing a functional configuration example (the second embodiment) of the information processing system. As shown in FIG. 22, the acquisition unit 320 of the printing apparatus 100 according to the second embodiment is different from the first embodiment in that the acquisition unit 320 of the printing apparatus 100 according to the second embodiment acquires environmental property information 540 in addition to the print property information 530.

The acquisition unit 320 of the printing apparatus 100 according to the second embodiment acquires temperature information 541 and moisture information 542 as the environmental property information 540. The temperature information 541 is numerical data corresponding to the temperature measured by the temperature sensor 151 and the moisture information 542 is numerical data corresponding to the moisture measured by the moisture sensor 152.

In addition, the acquisition unit 320 according to the second embodiment is realized when the CPU 111 reads the program installed in the storage 113 to the memory 112, executes the program, and controls the temperature sensor 151, the moisture sensor 152, etc.

In addition, the second embodiment is different from the first embodiment in terms of inquiry data 500b, the color verification result data 700, the result data 800, the determination data 900, and processing content by the determination unit 430 of the server 200, etc., and details thereof will be described below.

### [Operation of Information Processing System 10]

### (2-1) Compliance Notification Process

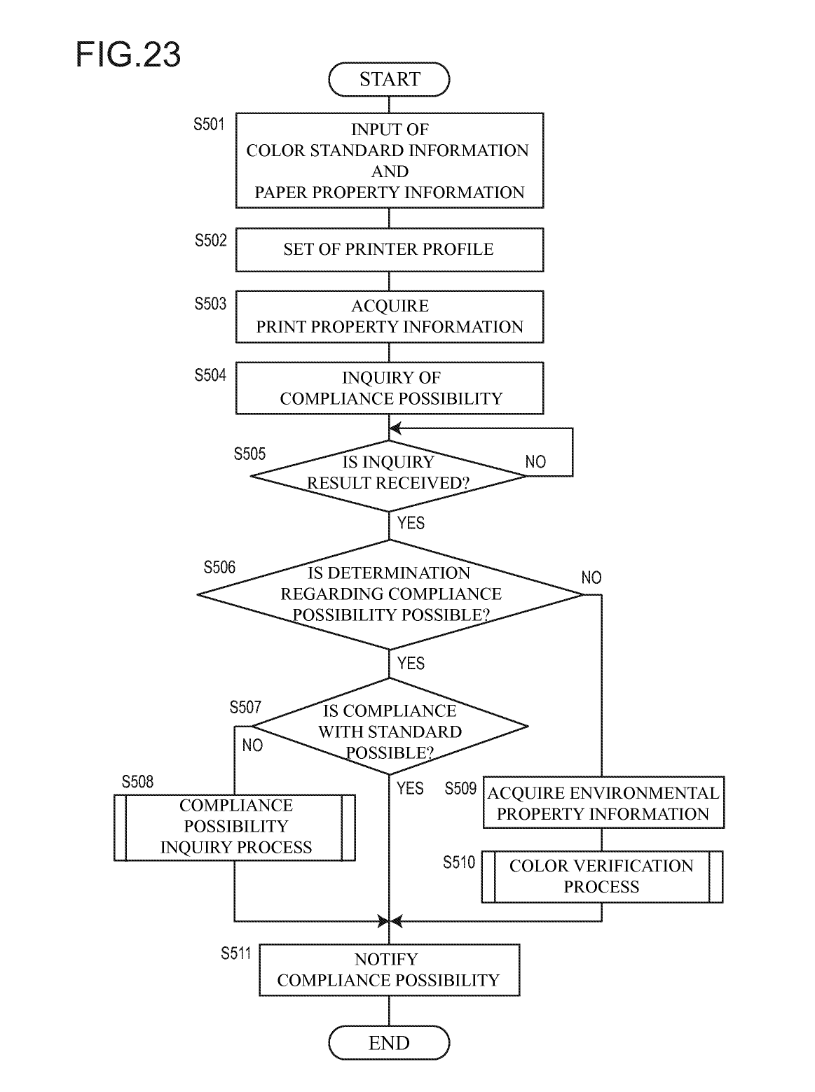

FIG. 23 is a flowchart of the compliance notification process (the second embodiment). In addition, the compliance notification process according to the second embodiment is performed in the printing apparatus 100.

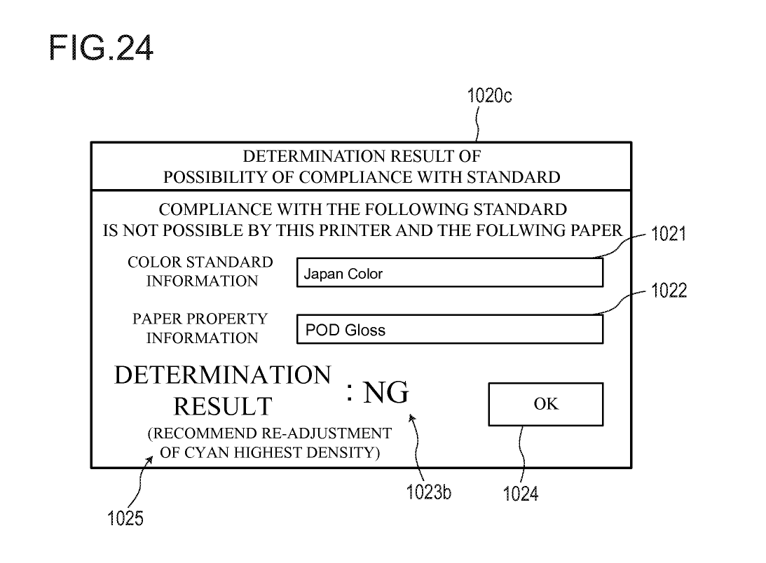

Furthermore, FIG. 24 is a diagram showing a third display example (the second embodiment) of a notification screen.

Hereinafter, with reference to FIG. 23 and FIG. 24, a procedure of the compliance notification process according to the second embodiment will be described.

The control device 110 of the printing apparatus 100 starts the compliance notification process according to the second embodiment at a timing similar to that of the first embodiment.

### (Steps S501 to S506)

When the compliance notification process is started, the printing apparatus 100 performs the same processes as those of steps S101 to S106 according to the first embodiment. Therefore, a detailed description of steps S101 to S106 will be omitted.

However, when it is determined that the determination is possible in step S506 (corresponding to step S106) (step S506: YES), the printing apparatus 100 allows the procedure to proceed to step S507. On the other hand, when it is determined that the determination is not possible in step S506 (step S506: NO), the printing apparatus 100 notifies the color verification unit 360 of the inquiry result and allows the procedure to proceed to step S509.

### (Step S507)

The printing apparatus 100 serves as the reception unit 340 and determines whether the inquiry result is “compliance is possible” or “compliance is not possible”.

When the inquiry result received in step S505 is “compliance is possible” (step S507: YES), the printing apparatus 100 notifies the notification unit 350 of the inquiry result and allows the procedure to proceed to step S511. On the other hand, when it is determined that the inquiry result is “compliance is not possible” (step S507: NO), the printing apparatus 100 allows the procedure to proceed to step S508.

### (Step S508)

The printing apparatus 100 serves as the acquisition unit 320, the transmission unit 330, and the reception unit 340 and performs a compliance possibility inquiry process according to the second embodiment. The compliance possibility inquiry process according to the second embodiment is performed, so that it is possible to inquire of the server 200 about whether printing complying with the designated standard is possible if the property of the printing apparatus 100 is changed. Details of the compliance possibility inquiry process according to the second embodiment will be described later.

When the compliance possibility inquiry process of step S508 is completed, the printing apparatus 100 allows the procedure to proceed to step S511.

### (Step S509)

The printing apparatus 100 serves as the acquisition unit 320 and acquires the environmental property information 540 which is information on a peripheral environment of its own apparatus. In detail, the printing apparatus 100 acquires, as the environmental property information 540, the temperature information 541 indicating the peripheral temperature of its own apparatus and the moisture information 542 indicating the peripheral moisture of its own apparatus. For example, the printing apparatus 100 can control the temperature sensor 151 to measure the peripheral temperature of its own apparatus and convert the peripheral temperature into numerical data, thereby acquiring the temperature information 541. Furthermore, the printing apparatus 100 can control the moisture sensor 152 to measure the peripheral moisture of its own apparatus and convert the peripheral moisture into numerical data, thereby acquiring the moisture information 542.

### (Step S510)

The printing apparatus 100 serves as the color verification unit 360 and performs a color verification process according to the second embodiment. The color verification process according to the second embodiment is performed, so that it is possible to determine whether printing complying with the designated standard is possible in the printing apparatus 100 even when a result (the result data 800) printed under the same condition in the past has not been accumulated in the server 200. Details of the color verification process according to the second embodiment will be described later.

After the color verification process of step S510 is completed, the printing apparatus 100 allows the procedure to proceed to step S511.

### (Step S511)

The printing apparatus 100 serves as the notification unit 350 and notifies a user of the inquiry result from the server 200. The inquiry result includes a determination result by the server 200 regarding whether printing complying with the designated standard is possible in its own apparatus. Furthermore, if the property (a property indicating print property information) of its own apparatus, particularly, the highest density of at least one color material, is changed, the inquiry result also includes a determination result by the server 200 regarding whether printing complying with the designated standard is possible.

In detail, when “compliance is possible” is determined in step S507, the printing apparatus 100 displays the notification screen 1020a of the first display example as shown in FIG. 9 on the external display (not shown) or the operating panel unit 120.

Furthermore, when “compliance is not possible” is determined in step S507 and “absence of compliance possibility” is determined for at least one color material in step S508, the printing apparatus 100 displays the notification screen 1020b of the second display example as shown in FIG. 10.

Furthermore, when “compliance is not possible” is determined in step S507 and there is no color material for which “absence of compliance possibility” has been determined in step S508, the printing apparatus 100 displays a notification screen 1020c of a third display example as shown in FIG. 24.

Furthermore, when “determination is not possible” is determined in step S506 and “compliance is possible” is determined in step S510, the printing apparatus 100 displays the notification screen 1020a of the first display example as shown in FIG. 9.

Furthermore, when “determination is not possible” is determined in step S506 and “compliance is not possible” is determined in step S510, the printing apparatus 100 displays the notification screen 1020b of the second display example as shown in FIG. 10.

In addition, the notification screen 1020c of the third display example is a screen for notifying a user that printing complying with the designated standard is possible if the property of the printing apparatus 100 intended to perform printing, particularly, the highest density of a color material for which “presence of compliance possibility” has been determined, is changed. In detail, the notification screen 1020c of the third display example is provided with a first column 1021 for displaying the designated color standard information 510 and a second column 1022 for displaying the paper property information 520 on a print paper to be used in printing. Moreover, on the notification screen 1020c of the third display example, a character string (may also be an image) 1023c for notifying a user that printing complying with the designated standard is not possible in its own apparatus at the present time point is displayed. In addition, a character string (may also be an image) 1025 for notifying a user that printing complying with the designated standard is possible if the highest density of at least one color material is changed is displayed. Moreover, the notification screen 1020c of the third display example is provided with an OK button 1024 for preventing the screen 1020c from being displayed when the user has confirmed the notification content.

When the process of step S511 is ended, the printing apparatus 100 ends the compliance notification process according to the second embodiment.

The aforementioned compliance notification process according to the second embodiment is performed, so that it is possible to notify a user whether printing complying with the designated standard is possible in the printing apparatus 100. Moreover, even when it is determined that printing complying with the designated standard is not possible in the printing apparatus 100, if the highest density of at least one color material is changed, it is possible to notify a user of whether printing complying with the designated standard is possible. Since these notifications are performed before printing, if printing complying with the designated standard is not possible, the user can stop printing or perform printing after changing the highest density of at least one color material, thereby reducing the generation of waste papers.

### (2-2) Compliance Possibility Inquiry Process

Next, the compliance possibility inquiry process (S508) according to the second embodiment will be described.

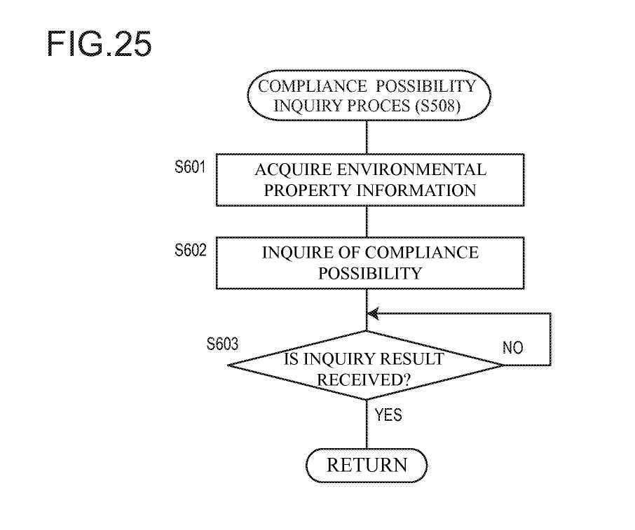

FIG. 25 is a flowchart of the compliance possibility inquiry process (the second embodiment). In addition, the compliance possibility inquiry process according to the second embodiment is performed in the printing apparatus 100.

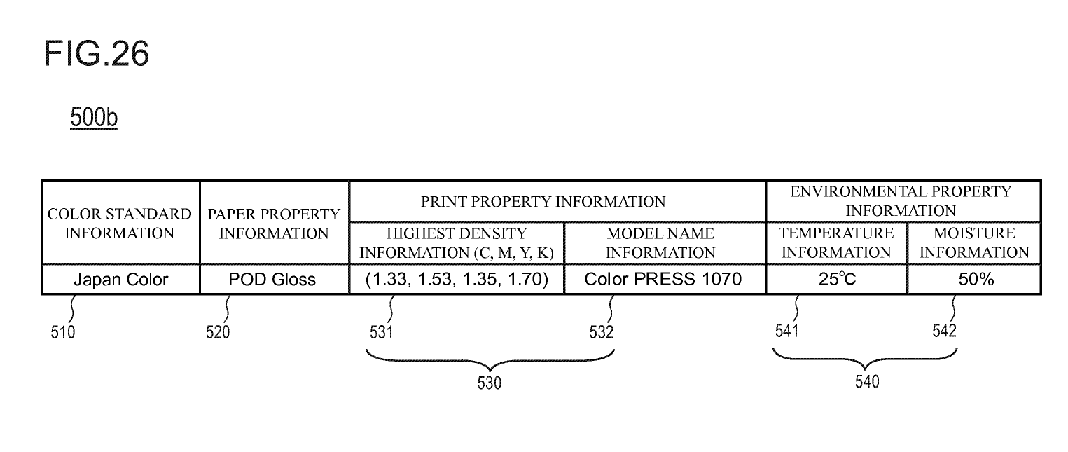

FIG. 26 is a diagram showing a schematic data structure example (the second embodiment) of inquiry data for compliance possibility determination.

Hereinafter, with reference to FIG. 25 and FIG. 26, a procedure of the compliance possibility inquiry process according to the second embodiment will be described.

When the procedure proceeds to step S508 of the aforementioned compliance notification process of the second embodiment, the control device 110 of the printing apparatus 100 starts the compliance possibility inquiry process.

### (Step S601)

When the compliance possibility inquiry process is started, the printing apparatus 100 serves as the acquisition unit 320 and acquires the environmental property information 540 which is information on the peripheral environment of its own apparatus. In detail, the printing apparatus 100 acquires, as the environmental property information 540, the temperature information 541 indicating the peripheral temperature of its own apparatus and the moisture information 542 indicating the peripheral moisture of its own apparatus. For example, the printing apparatus 100 can control the temperature sensor 151 to measure the peripheral temperature of its own apparatus and convert the peripheral temperature into numerical data, thereby acquiring the temperature information 541. Furthermore, the printing apparatus 100 can control the moisture sensor 152 to measure the peripheral moisture of its own apparatus and convert the peripheral moisture into numerical data, thereby acquiring the moisture information 542.

### (Step S602)

The printing apparatus 100 serves as the transmission unit 330, and inquires of the server 200 about whether printing complying with the designated standard is possible if the property of its own apparatus, particularly, the highest density of at least one color material is changed. In detail, the printing apparatus 100 transmits the inquiry data 500b for compliance possibility determination according to the second embodiment as shown in FIG. 26 to the server 200. The inquiry data 500b for compliance possibility determination according to the second embodiment has a data structure different from that of the inquiry data 500a. In detail, in the inquiry data 500b, the color standard information 510 and the paper property information 520 input in step S501, the print property information 530 acquired in step S503, and the environmental property information 540 acquired in step S601 are associated with one another. In addition, the environmental property information 540 includes the aforementioned temperature information 541 and moisture information 542.

### (Step S603)

The printing apparatus 100 serves as the reception unit 340 and determines whether an inquiry result from the server 200 has been received. The inquiry result includes information indicating whether printing complying with the designated standard is possible if the highest density of at least one color material is changed. Moreover, the inquiry result also includes information indicating whether printing complying with the designated standard is possible if the highest density of a certain color material is changed. When the inquiry result has not been received (step S603: NO), the printing apparatus 100 waits until the inquiry result is received from the server 200. On the other hand, when the inquiry result has been received (step S603: YES), the printing apparatus 100 allows the procedure to return to step S511 of the compliance notification process according to the second embodiment.

The aforementioned compliance possibility inquiry process according to the second embodiment is performed, so that it is possible to inquire of the server 200 about whether printing complying with the designated standard is possible if the property of the printing apparatus 100 is changed.

### (2-3) Color Verification Process

Next, the color verification process (S510) according to the second embodiment will be described. The printing apparatus 100 according to the second embodiment performs a color verification process approximately the same as the color verification process (S107) according to the first embodiment shown in FIG. 11.

In the color verification process according to the second embodiment, the difference with the first embodiment is a data structure of color verification result data 700 provided from the printing apparatus 100 to the server 200.

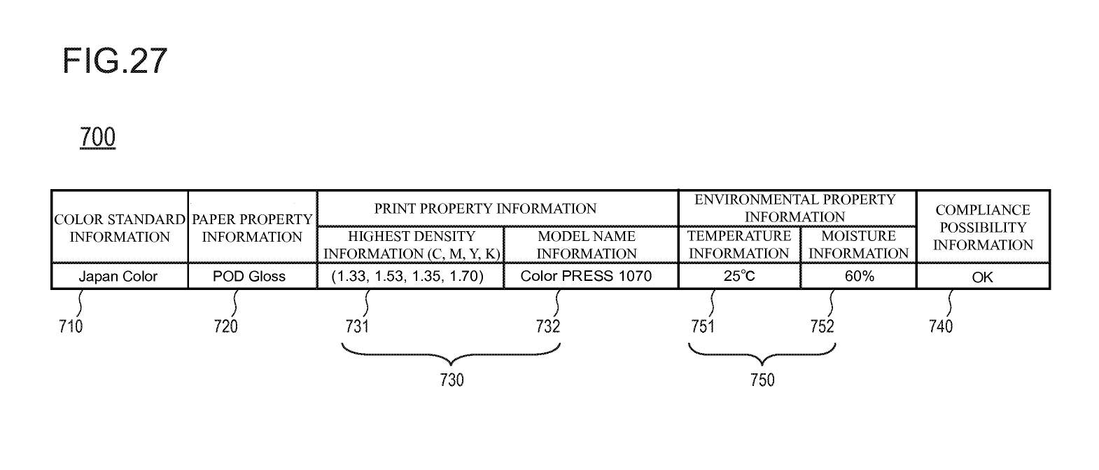

FIG. 27 is a diagram showing a schematic data structure example (the second embodiment) of color verification result data. The color verification result data 700 according to the second embodiment has a data structure in which the color standard information 710, the paper property information 720, the print property information 730, and the compliance possibility information 740 have been associated with environmental property information 750 as shown in FIG. 27. In addition, the environmental property information 750 includes temperature information 751 and moisture information 752. The temperature information 751 is information corresponding to the temperature information 541 acquired in step S509 and moisture information 752 is information corresponding to the moisture information 542 acquired in step S509.

The color verification process according to the second embodiment is performed, so that whether printing complying with the designated standard is possible can be independently in the printing apparatus 100 even when a result (the result data 800) printed under the same condition in the past has not been accumulated in the server 200.

### (2-4) Result Data Accumulation Process

Next, the result data accumulation process according to the second embodiment will be described. The server 200 according to the second embodiment performs a result data accumulation process approximately the same as the result data accumulation process according to the first embodiment shown in FIG. 15.

In the result data accumulation process according to the second embodiment, the difference with the first embodiment is a data structure of result data 800 accumulated in the accumulation unit 410.

### (Result Data 800 According to the Second Embodiment)

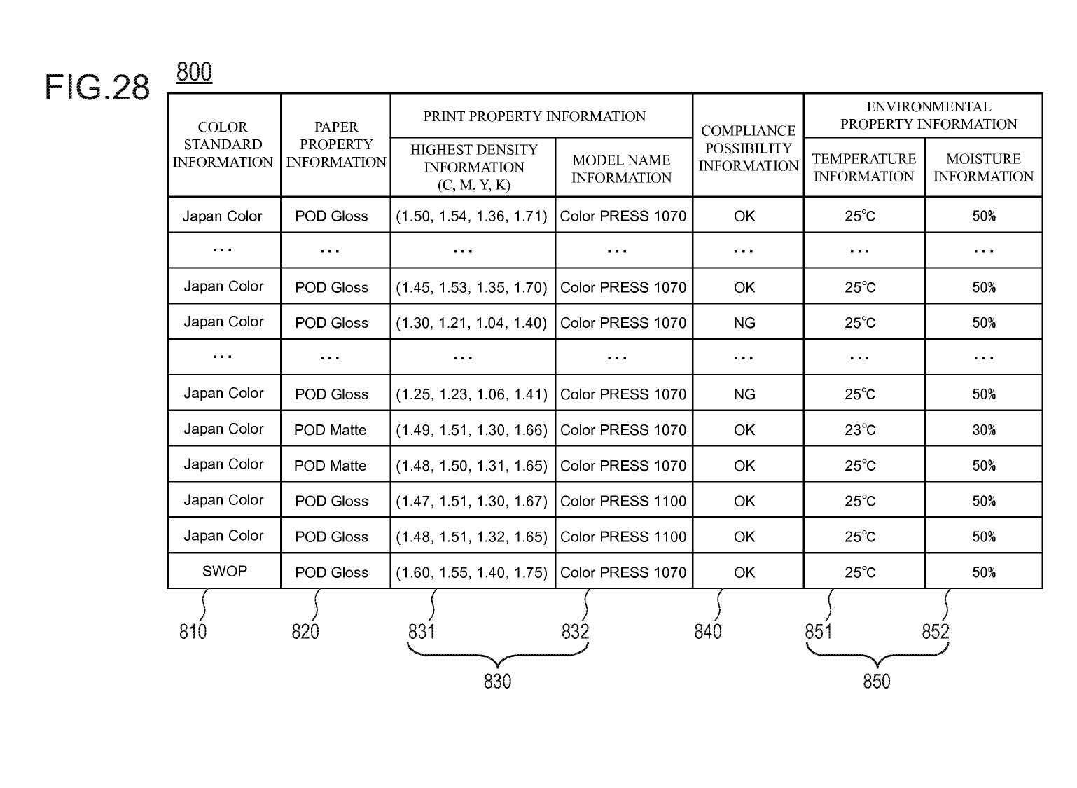

FIG. 28 is a schematic data structure example (the second embodiment) of result data. The result data 800 according to the second embodiment has a data structure in which the color standard information 810, the paper property information 820, the print property information 830, and the compliance possibility information 840 have been associated with environmental property information 850 as shown in FIG. 28.

Since the information 810, 820, 830, and 840, other than the environmental property information 850, are equal to the information included in the result data 800 of the first embodiment, a detailed description thereof will be omitted.

The environmental property information 850 is information indicating the peripheral environment of the printing apparatus 100 when the printing apparatus 100 has performed the printing (the printing of the color verification chart 600). In detail, the environmental property information 850 includes temperature information 851 indicating temperature at the time of the printing and moisture information 852 indicating moisture at the time of the printing in the printing apparatus 100 having performed the printing. The temperature information 851 is configured by a character string of “25° C.”, etc. The moisture information 852 is configured by a character string of “50%”, etc.

However, similarly to the first embodiment, when only one type of standard (for example, “Japan Color”) can be designated in the printing apparatus 100, the color standard information 810 may not be included in the result data 800. Consequently, it can be said that the result data 800 according to the second embodiment is data in which the compliance possibility information 840 is accumulated in each combination of at least the paper property information 820, the print property information 830, and the environmental property information 850.

As described above, since the data structure example of the result data 800 according to the second embodiment is different from that of the first embodiment, the processing content of step S302 of the result data accumulation process according to the second embodiment is also different.

In detail, in step S302, the server 200 serves as the result data management unit 450 and accumulates the color verification result data 700 according to the second embodiment in the accumulation unit 410. That is, the server 200 associates the color standard information 710, the paper property information 720, the print property information 730, the compliance possibility information 740, and the environmental property information 750, which are included in the color verification result data 700 as shown in FIG. 27, with one record, and accumulates them as the accumulated data 800.

After the process of step S302 is ended, the server 200 ends the result data accumulation process according to the second embodiment.

The aforementioned result data accumulation process is performed, so that the server 200 can accumulate a result (information regarding whether printing complies with the designated standard) of the printing whenever the printing (the printing of the color verification chart 600) is performed in the printing apparatus 100.

### (2-5) Compliance Determination Process

The compliance determination process according to the second embodiment is equal to the compliance determination process according to the first embodiment as shown in FIG. 17. Consequently, a description thereof will be omitted.

### (2-6) Compliance Possibility Determination Process

Next, the compliance possibility determination process according to the second embodiment will be described.

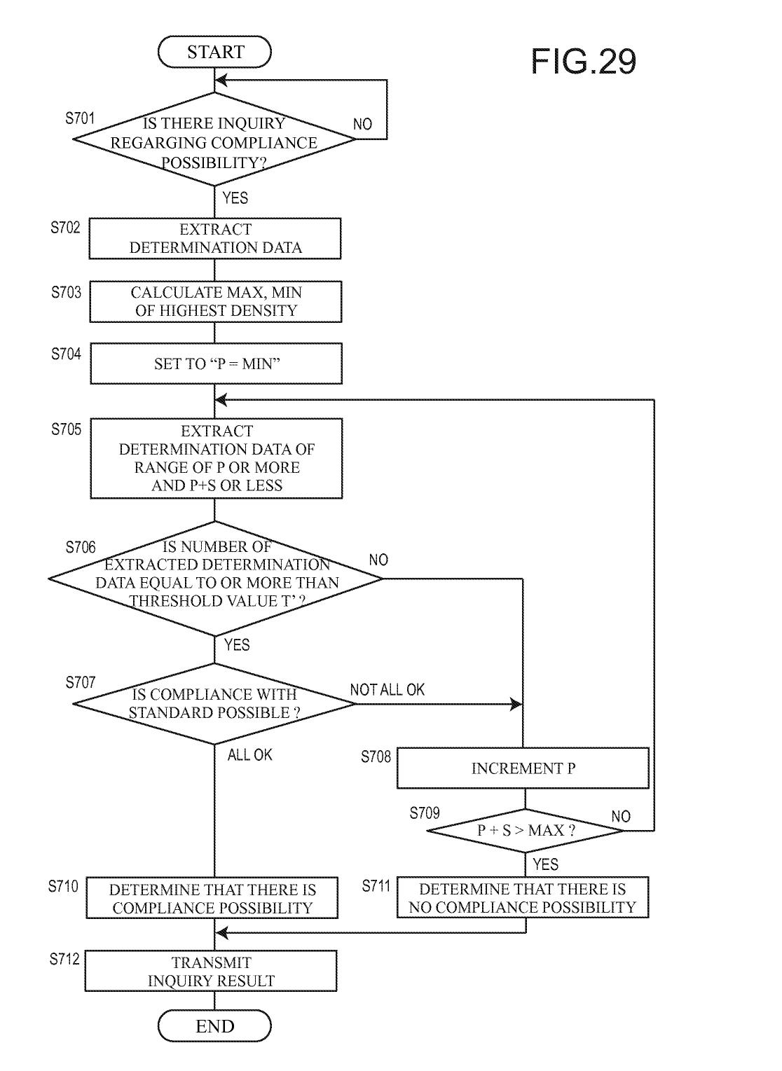

FIG. 29 is a flowchart of the compliance possibility determination process (the second embodiment). The compliance possibility determination process is a process for determining whether printing complying with the designated standard is possible in the printing apparatus 100 if the property of the printing apparatus 100 is changed, in response to an inquiry from the printing apparatus 100. In addition, the compliance possibility determination process is performed in the server 200.

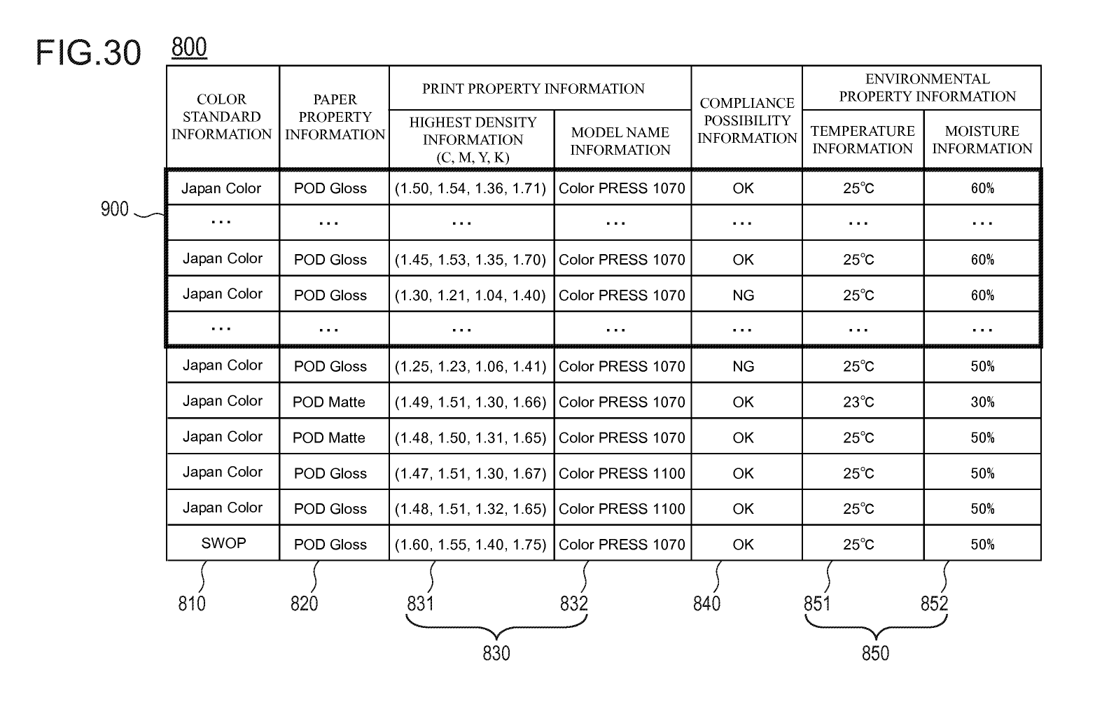

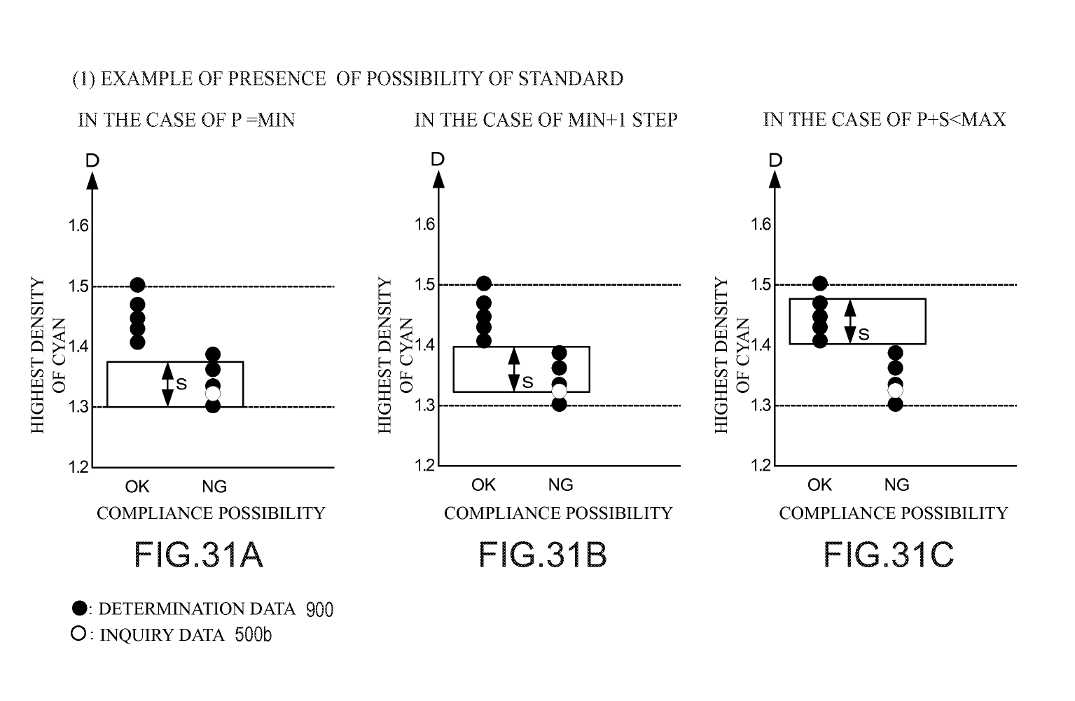

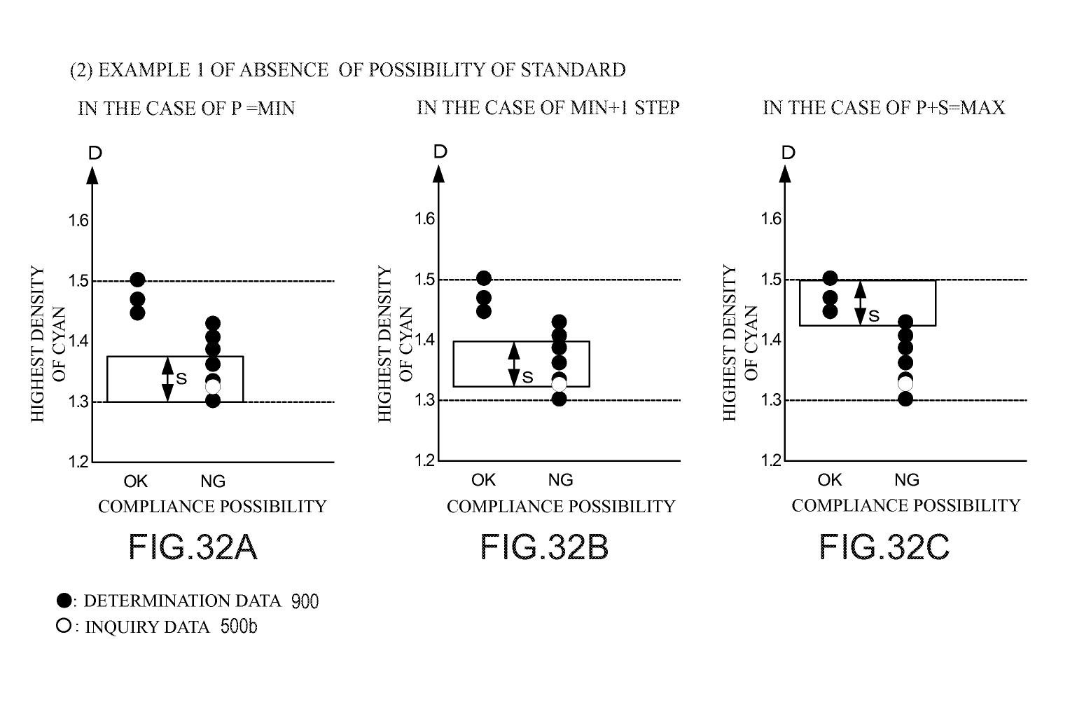

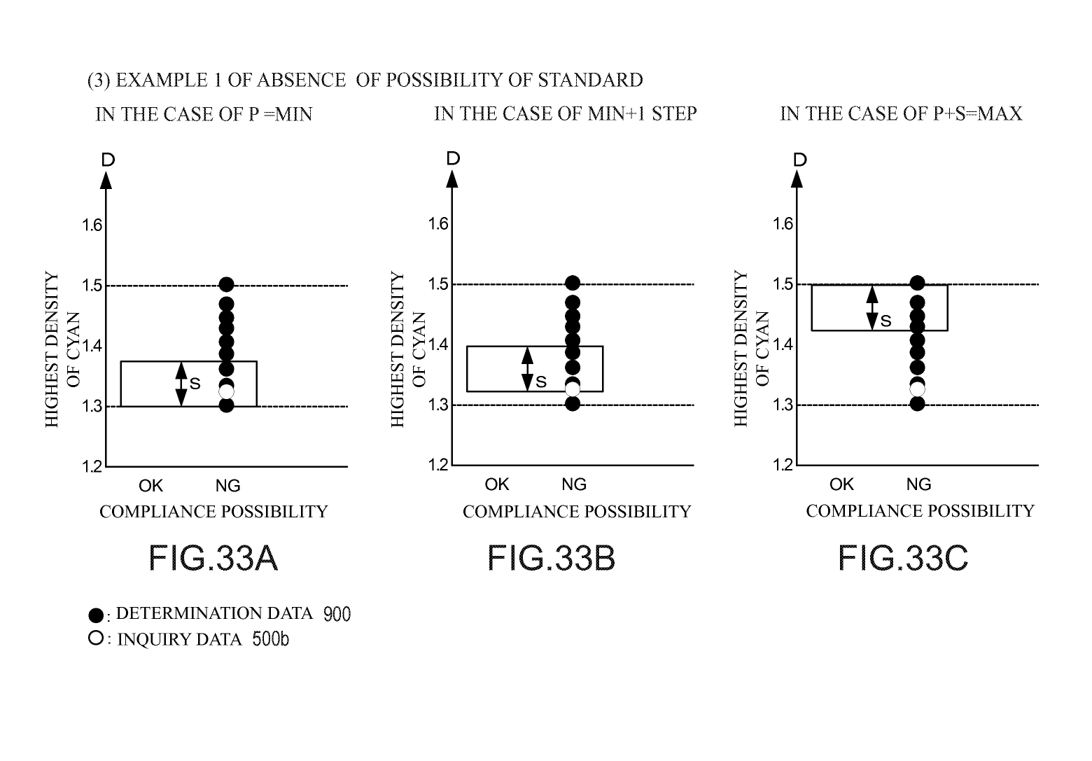

Furthermore, FIG. 30 is a diagram for explaining an extraction method (the second embodiment) of determination data. FIG. 31 is a diagram showing an example when it is determined that compliance with a standard is possible. FIG. 32 is a diagram showing an example 1 when it is determined that compliance with the standard is not possible. FIG. 33 is a diagram showing an example 2 when it is determined that compliance with the standard is not possible.

Hereinafter, with reference to FIG. 29 to FIG. 33, a procedure of the compliance possibility determination process will be described.

The control device 210 of the server 200 starts the compliance possibility determination process when the server 200 is powered on.

### (Step S701)

When the compliance possibility determination process is started, the server 200 serves as the reception unit 420, and determines whether there is an inquiry from the printing apparatus 100 regarding whether printing complying with the designated standard is possible if the property of the printing apparatus 100 is changed. In detail, the server 200 determines the presence or absence of the inquiry from the printing apparatus 100 in response to whether the inquiry data 500b for compliance possibility determination transmitted from the printing apparatus 100 in step S602 has been received.

When the inquiry data 500b for compliance possibility determination has not been received, the server 200 determines that there is no inquiry from the printing apparatus 100 (step S701: NO) and waits until there is the inquiry. On the other hand, when the inquiry data 500b for compliance possibility determination has been received, the server 200 determines that there is the inquiry from the printing apparatus 100 (step S701: YES) and allows the procedure to proceed to step S702.

### (Step S702)

The server 200 serves as the determination unit 430 and extracts minimum determination data 900, which is required for determining whether printing complying with the designated standard is possible if the property of the printing apparatus 100 is changed, from the accumulated data 800. In detail, the server 200 extracts a record having all pieces of data coinciding with the color standard information 510, the paper property information 520, the model name information 532, the temperature information 541, and the moisture information 542 included in the inquiry data 500b for compliance possibility determination received in step S701. For example, in an example shown in FIG. 30, the server 200 extracts, as the determination data 900, a record having all of “Japan Color”, “POD Gloss”, “Color PRESS 1070”, “25° C.”, and “60%” (inside the thick frame).

### (Step S703)

The server 200 serves as the determination unit 430 and calculates a maximum value Max and a minimum value Min of the highest density information 831 by using the determination data 900 extracted in step S702. However, the server 200 does not need to calculate the maximum value Max and the minimum value Min of the highest density information 831 with respect to all the color materials (C, M, Y, and K). It is sufficient if the server 200 calculates the maximum value Max and the minimum value Min of the highest density information 831 with respect to only a color material for which all the compliance possibility information 840 has been determined as “compliance is not possible (NG)” in step S404.

Hereinafter, a description will be provided for the case in which the color material for which all the compliance possibility information 840 has been determined as “compliance is not possible (NG)” in step S404 is only cyan (C).

In the example shown in FIG. 30, among all pieces of determination data 900, the maximum value Max of the highest density information 831 of cyan (C) is “1.50” and the minimum value Min is “1.30”. In this case, the server 200 calculates the maximum value Max and the minimum value Min of the highest density information 831 of cyan (C) to “1.50” and “1.30”, respectively.

In addition, when the color material for which all the compliance possibility information 840 has been determined as “compliance is not possible (NG)” in step S404 is plural, processes of the following steps S704 to S711 are performed independent of each color.

### (Step S704)

The server 200 serves as the determination unit 430 and provides a variable P. Furthermore, the server 200 puts the minimum value Min of the highest density information 831 calculated in step S703 into the variable P (set the variable P as Min).

### (Step S705)

The server 200 serves as the determination unit 430 and extracts determination data 900 having the highest density information 831 in the range of P or more and P+S or less from all pieces of determination data 900. S is a constant and for example, it is assumed that “S=0.75”. Furthermore, hereinafter, a value of the highest density information 831 is set as D.

FIG. 31A is an example 1 of a graph in which all pieces of determination data 900 are plotted with black circles and a range of Min≦D≦Min+S is indicated by a rectangular solid line frame. FIG. 32A is an example 2 of a graph in which all pieces of determination data 900 are plotted with black circles and a range of Min≦D≦Min+S is indicated by a rectangular solid line frame. FIG. 33A is an example 3 of a graph in which all pieces of determination data 900 are plotted with black circles and a range of Min≦D≦Min+S is indicated by a rectangular solid line frame.

When P is equal to Min, the server 200 extracts determination data 900 within the ranges of the rectangular solid line frames shown in FIG. 31A, FIG. 32A, and FIG. 33A in step S705.

### (Step S706)

The server 200 serves as the determination unit 430, counts the number of determination data 900 within the range of P≦D≦P+S (inside the rectangular solid line frame) extracted in step S705, and determines whether the number is equal to or more than a threshold value T′.

In all the examples of FIG. 31A, FIG. 32A, and FIG. 33A, four pieces of determination data 900 are inside the rectangular solid line frames.

The server 200 determines whether the number of determination data 900 counted as described above is equal to or more than the threshold value T′ (for example, three), and allows the procedure to proceed to step S707 when the number is equal to or more than the threshold value T′. On the other hand, when the counted number of determination data 900 is smaller than the threshold value T′ (for example, three), the server 200 allows the procedure to proceed to step S708.

### (Step S707)

The server 200 serves as the determination unit 430 and refers to the compliance possibility information 840 of the determination data 900 within the range of P≦D≦P+S (inside the rectangular solid line frame) extracted in step S705.

In the examples of FIG. 31A, FIG. 32A, and FIG. 33A, since all pieces of determination data 900 within the range of P≦D≦P+S (inside the rectangular solid line frame) is “compliance is not possible (NG)”, the server 200 allows the procedure to proceed to step S708.

### (Step S708)

The server 200 serves as the determination unit 430 and increments the variable P by one step. For example, one step is assumed to “0.2”. Then, the server 200 allows the procedure to proceed to step S709.

### (Step S709)

The server 200 serves as the determination unit 430 and determines whether P+S is larger than Max. “P+S” corresponds to an upper limit value of the rectangular solid line frames shown in FIG. 31A to FIG. 33C. Consequently, the process of step S709 is a process for determining whether the upper limit value of the rectangular solid line frame has exceeded the maximum value Max of the highest density information 831 calculated in step S703.

When P+S is larger than Max (step S709: YES), the server 200 allows the procedure to proceed to step S711. On the other hand, when P+S is not larger than Max (step S709: NO), the server 200 returns the procedure to step S705.

The aforementioned processes of steps S705 to S709 are repeated by incrementing P until all pieces of determination data 900 inside the rectangular solid line frame is “compliance is possible (OK)” but P+S is larger than Max (step S709: YES).

The example of FIGS. 31A-31C will be described. In the stages of FIGS. 31A and 31B, determination data 900 of “compliance is not possible (NG)” is included inside the rectangular solid line frames. Therefore, the server 200 increments P to repeat the processes of steps S705 to S709. Then, in the stage of FIG. 31C, all pieces of determination data 900 inside the rectangular solid line frame is initially “compliance is possible (OK)”. At this time, the server 200 allows the procedure to proceed to step S710 from step S707.

Furthermore, the example of FIGS. 32A-32C will be described. In the stages of FIGS. 32A and 32B, determination data 900 of “compliance is not possible (NG)” is included inside the rectangular solid line frames. Therefore, the server 200 increments P to repeat the processes of steps S705 to S709. Then, as shown in FIG. 32C, determination data 900 of “compliance is possible (OK)” is included inside the rectangular solid line frame, but determination data 900 of “compliance is not possible (NG)” is still also included inside the rectangular solid line frame. In this case, even though the processes of steps S705 to S709 are repeated, all pieces of determination data 900 inside the rectangular solid line frame is not “compliance is possible (OK)” while P is being incremented from “P=Min” to “P+S>Max”. Then, at the time point at which P+S is larger than Max, the server 200 allows the procedure to proceed to step S711 from step S709.

Furthermore, the example of FIGS. 33A-33C will be described. In all the stages of FIG. 33A to 33C, determination data 900 of “compliance is not possible (NG)” is included inside the rectangular solid line frames. In this case, even though the processes of steps S705 to S709 are repeated, all pieces of determination data 900 inside the rectangular solid line frame is not “compliance is possible (OK)” while P is being incremented from “P=Min” to “P+S>Max”. At the time point at which P+S is larger than Max, the server 200 allows the procedure to proceed to step S711 from step S709.

### (Step S710)

The server 200 serves as the determination unit 430 and determines that there is possibility of compliance with the designated standard. As indicated by the inquiry data 500b indicated by a white circle of FIG. 31C, in the property of the printing apparatus 100 at the current time point, the highest density information 831 is “1.33” and the compliance with the designated standard is not possible (NG). However, when the highest density of cyan is increased (for example, 1.4 or more), since there is possibility of compliance with the designated standard, the server 200 determines that there is the possibility of the compliance with the designated standard in step S710.

### (Step S711)

The server 200 serves as the determination unit 430 and determines that there is no possibility of compliance with the designated standard. As indicated by the inquiry data 500b indicated by white circles of FIGS. 32A to 33C, in the property of the printing apparatus 100 at the current time point, the highest density information 831 is “1.33” and the compliance with the designated standard is not possible (NG). However, even though the highest density of cyan is changed (increased or decreased), since there is no possibility of the compliance with the designated standard, the server 200 determines that there is no possibility of the compliance with the designated standard in step S711.

### (Step S712)

The server 200 serves as the transmission unit 440 and provides the determination result in step S710 or S711 to the printing apparatus 100 as an inquiry result (corresponding to step S603). That is, the server 200 transmits, to the printing apparatus 100, information indicating whether printing complying with the designated standard is possible if the highest density of the color material (the aforementioned cyan, etc.), for which all the compliance possibility information 840 has been determined as “compliance is not possible (NG)” in step S404, is changed.

After the process of step S712 is ended, the server 200 ends the compliance possibility determination process.

The aforementioned compliance possibility determination process is performed, so that the server 200 can combine the paper property information 520 and the print property information 530 with each other to refer to the past operation result (the result data 800), thereby determining whether compliance with a standard of a print color is possible. Moreover, the server 200 refers to the result data 800 of the accumulation unit 410 in addition to the environmental property information 540, thereby determining whether printing complying with the standard based on the color standard information 510 is possible if the property of the printing apparatus 100 is changed under the current environment (temperature and moisture). Consequently, when the past operation result exists, even though a color verification chart is printed and colors of a plurality of patches are not measured, it is possible to determine the possibility of the compliance with the standard of the print color is possible and the possibility of compliance due to a change (re-adjustment) in the property of the printing apparatus 100. As a consequence, it is possible to reduce the generation of waste papers and effort of a user.

In addition, each processing unit of the aforementioned each flowchart has been divided in response to main processing content in order to facilitate the understanding of the information processing system 10. The present invention is not limited by a scheme of classification of processing steps and a name thereof. A process performed in the information processing system 10 can also be divided into many more processing steps. Furthermore, one processing step may also perform many more processes.

### MODIFICATION

Furthermore, the aforementioned each embodiment intends to exemplify the scope of the present invention and does not limit the present invention. Many alternatives, corrections, and modifications are obvious for those skilled in the art.

For example, in the aforementioned each embodiment, the result data 800 is accumulated in the accumulation unit 410 of the server 200, and the compliance determination process and the compliance possibility determination process are performed in the server 200. However, the present invention is not limited thereto, and the whole or apart of the functions of the aforementioned server 200 may also be imparted to the printing apparatus 100. In this case, the functions of the server 200 may also be imparted to one printing apparatus 100, or the functions of the server 200 may also be distributed and imparted to a plurality of printing apparatuses 100.

The configuration of the aforementioned information processing system 10 has been described in order to describe main elements when describing the characteristics of the aforementioned each embodiment, and the present invention is not limited to the aforementioned configuration. Furthermore, a configuration of a general information processing system 10 is not excluded.

Furthermore, each functional configuration of the information processing systems 10 shown in FIG. 4 and FIG. 22 has been classified in response to main processing content in order to facilitate the understanding of each functional configuration. The present invention is not limited by a scheme of classification of elements and a name thereof. Each functional configuration can also be classified into many more elements in response to processing content. Furthermore, one element can also be classified so as to perform many more processes.

Furthermore, the processes of each functional configuration shown in FIG. 4 and FIG. 22 can also be realized by a dedicated hardware circuit. In this case, the processes may also be performed by one type of hardware or a plurality of types of hardware.

Furthermore, a program for operating the information processing system 10 may also be provided by a computer-readable recording medium such as a USB memory, a flexible disk, and CD-ROM, or may also be provided online via a network such as the Internet. In this case, the program stored in the computer-readable recording medium is normally transmitted to and stored in a memory (112 or 212) or a storage (113 or 213). Furthermore, the program, for example, may also be provided as single application software, or may also be embedded as software of each apparatus as one function of the information processing systems 10.

What is claimed is:

1. An information processing system comprising:
an accumulation unit for accumulating a print result as result data;
an input acceptance unit for accepting input of color standard information indicating a standard of a print color and paper property information indicating a property of a print paper;
an acquisition unit for acquiring print property information indicating a property of a printing apparatus that performs printing on said print paper;
a determination unit for referring said color standard information and said paper property information, which have been input to said input acceptance unit, and said print property information, which has been acquired in said acquisition unit, to said result data of said accumulation unit, and determining whether printing to be performed complies with a standard based on said color standard information; and
a notification unit for notifying a determination result determined by said determination unit.

2. An information processing system comprising:
an accumulation unit for accumulating a print result as result data;
an input acceptance unit for accepting input of color standard information indicating a standard of a print color and paper property information indicating a property of a print paper;
an acquisition unit for acquiring print property information indicating a property of a printing apparatus that performs printing on said print paper, and environmental property information indicating a use environment of said printing apparatus;
a determination unit for referring said color standard information and said paper property information, which have been input to said input acceptance unit, and said print property information and said environmental property information, which have been acquired in said acquisition unit, to said result data of said accumulation unit, and determining whether printing when said property of said printing apparatus that performs printing has been changed complies with a standard based on said color standard information; and
a notification unit for notifying a determination result determined by said determination unit.

3. A non-transitory computer-readable recording medium stored with an information processing program, wherein said information processing program causing a computer having an accumulation unit for accumulating a print result as result data to execute a process comprising:
step (a) of accepting input of color standard information indicating a standard of a print color and paper property information indicating a property of a print paper;
step (b) of acquiring print property information indicating a property of a printing apparatus that performs printing on said print paper;
step (c) of referring said color standard information and said paper property information, which have been input in step (a), and said print property information, which has been acquired in step (b), to said result data of said accumulation unit, and determining whether printing to be performed complies with a standard based on said color standard information; and
step (d) of notifying a determination result determined in step (c).

4. The non-transitory computer-readable recording medium as claimed in claim 3, wherein
in said result data, each combination of said paper property information indicating said property of said print paper and said print property information indicating said property of said printing apparatus having performed said printing on said print paper is associated with compliance possibility information indicating whether said printing on said print paper by said printing apparatus complies with a standard designated at a time of said printing.

5. The non-transitory computer-readable recording medium as claimed in claim 3, wherein
said paper property information includes information indicating a paper brand.

6. The non-transitory computer-readable recording medium as claimed in claim 3, wherein
said print property information includes model name information and highest density information of each color material to be used in printing.

7. The non-transitory computer-readable recording medium as claimed in claim 6, wherein
in said (c), result data having said color standard information and said paper property information input in step (a) and said model name information acquired in step (b) is extracted from said result data of said accumulation unit as determination data, and
among said extracted determination data, by using determination data having highest density information within a predetermined range about a value indicated by said highest density information of each color material acquired in step (b), whether said printing to be performed complies with said standard based on said color standard information is determined.
